(19) United States
(12) Patent Application Publication
(10) Pub. No.: US 2026/0277912 A1
(43) Pub. Date: Sep. 17, 2026

(54) GENERALIZED USER INPUT COLLECTION FOR AGENT WORKFLOWS

(71) Applicant: NVIDIA Corporation, Santa Clara, CA (US)

(72) Inventors: Michael David Demoret, Brooklyn, NY (US); Dhruv Nandakumar, Boston, MA (US)

(21) Appl. No.: 19/358,873

(22) Filed: Oct. 15, 2025

Related U.S. Application Data
(60) Provisional application No. 63/772,596, filed on Mar. 16, 2025.

(51) Int. Cl. G06F 16/2457; G06F 16/242; G06F 16/26; G06F 16/29

(52) U.S. Cl. CPC G06F 16/24575; G06F 16/243; G06F 16/26; G06F 16/29

(57) ABSTRACT

An artificial intelligence (AI) agent system receives requests for user input from various workflows during execution. A user input manager identifies a registered callback handler associated with a specific user interface front-end, which corresponds to a particular interaction modality. The manager transmits the request to this front-end, which processes the input according to its modality and returns the user's input. The user input manager then routes the response to the original workflows, allowing the AI agent system to continue execution with the user's input.

### CROSS-REFERENCE TO RELATED APPLICATION

This application is a non-provisional of and claims priority to U.S. Provisional Application No. 63/772,596, filed Mar. 16, 2025, which is incorporated by reference herein in its entirety.

### TECHNICAL FIELD

This disclosure generally relates to AI agent workflow (e.g., artificial intelligence (AI) and/or language model [LM]) evaluation systems, and more particularly to computer-implemented architectures that facilitate intelligent assessment of AI/LM agent and/or AI agent workflow performance across multiple frameworks.

### BACKGROUND

Human-in-the-loop integration mechanisms for AI agent workflows suffer from technical constraints that impede the advancement of scalable context-agnostic feedback collection systems. Current frameworks for building and deploying AI agents support individual human interaction integration during development, but they are bottlenecked by limitations that prevent generalized user input functionality across heterogeneous execution environments and user interface modalities. These frameworks only work for agents where human interaction capabilities are manually hardcoded within their specific execution context, making it challenging for developers to implement environment-agnostic feedback collection across multiple front-end interfaces, such as command line terminals, API servers, voice input/output systems, and web-based graphical interfaces. This creates fragmented development approaches where developers cannot obtain unified human feedback integration across diverse execution contexts, resulting in repeated custom implementations and suboptimal agent component reusability.

The technical problem extends beyond context-specific implementations into the realm of agent workflow portability, where current development approaches focus primarily on static user interface integration and manual callback handler engineering without addressing dynamic front-end discovery, automatic modality adaptation, and execution-agnostic feedback capabilities. Traditional frameworks only consider predetermined interface configurations, failing to account for the complex abstraction requirements that emerge when agent components need to request human input across arbitrary execution environments without possessing knowledge of their deployment context. With large AI agentic systems where different workflows may utilize different front-end interfaces and interaction patterns, it becomes difficult to implement generalizable human feedback mechanisms when only specific execution environment configurations are supported during individual development cycles.

The technical constraints further manifest in the inability to perform execution-context-agnostic human input request routing, where developers may need to manually iterate through time-consuming cycles of interface-specific callback implementation, user interaction formatting, and response handling across disparate front-end environments. This manual intervention creates a development bottleneck as human feedback integration parameters such as interface selection, request formatting strategies, and response processing patterns need to be individually implemented without standardized abstractions or unified callback management capabilities. The lack of automated, context-agnostic human input routing mechanisms forces developers to make integration decisions based on incomplete visibility into their deployment environments, resulting in suboptimal agent component portability, unnecessary development overhead, and non-transferable human interaction implementations when multiple agent workflows require feedback capabilities across different front-end interface environments simultaneously.

### BRIEF DESCRIPTION OF THE DRAWINGS

The present systems and methods are described in detail below with reference to the attached drawing figures. To easily identify the discussion of any particular element or act, the most significant digit or digits in a reference number refer to the figure number in which that element is first introduced. In the drawing figures:

FIG. 1 illustrates an AI agent system, according to at least some embodiments of the present disclosure.

FIG. 2 is an AI agent workflow diagram, according to at least some embodiments of the present disclosure.

FIG. 3 illustrates a user input manager wrapper system, according to at least some embodiments of the present disclosure.

FIG. 4 illustrates a user input manager system, according to at least some embodiments of the present disclosure.

FIG. 5 is a flowchart illustrating an example method performed by the AI agent system, according to at least some embodiments of the present disclosure.

FIG. 6A is a diagram of an example generative language model system suitable for use in implementing at least some embodiments of the present disclosure.

FIG. 6B is a diagram of an example generative language model that includes a transformer encoder-decoder suitable for use in implementing at least some embodiments of the present disclosure.

FIG. 6C is a diagram of an example generative language model that includes a decoder-only transformer architecture suitable for use in implementing at least some embodiments of the present disclosure.

FIG. 7 is a diagram of an example computing device suitable for use in implementing at least some embodiments of the present disclosure.

FIG. 8 is a diagram of an example data center suitable for use in implementing at least some embodiments of the present disclosure.

### DETAILED DESCRIPTION

Systems and methods are disclosed related to context-agnostic human feedback collection and routing for AI agent workflows. Specifically, but not exclusively, this disclosure relates to universal human-in-the-loop integration systems, and to computer-implemented architectures that facilitate automated user input request routing and configurable front-end (FE) interface deployment across, for example, multi-modal agent implementations in heterogeneous execution environments.

The present disclosure provides systems and methods for implementing intelligent execution-context-agnostic human feedback collection through an architecture that enables universal user input management and standardized callback handler registration for AI agent workflows regardless of their underlying execution environments or FE interface modalities. The technology represents a significant advancement over conventional agent-user interaction systems by creating a unified framework (e.g., a user input manager system or sometimes referred to as a human-in-the-loop abstraction platform or context-agnostic feedback collection system) where dynamic FE interface discovery capabilities can automatically route human input requests to appropriate user interface modalities including command line terminals, API servers, voice input/output systems, and/or web-based graphical interfaces while maintaining complete execution context isolation through standardized callback handler registration and user input manager provisioning mechanisms.

The disclosed system supports comprehensive modality-specific interaction processing that enables developers to separate agent logic operations from execution context dependencies by automatically generating context-appropriate request formats using registered callback handlers and passing them to FE interfaces for efficient human interaction processing. The architecture extends beyond simple input/output coordination to provide granular request-level routing wrapper deployment, automatic modality adaptation capabilities, and/or behavioral characteristic identification at a level of detail previously unavailable across multiple execution contexts and FE interface types. This holistic approach enables optimization insights ranging from agent component portability through execution context abstraction and automated request routing to workflow composition flexibility and configuration-driven callback handler deployment while maintaining developer agent independence and supporting seamless integration with existing agent implementations through standardized user input manager mechanisms and dynamic front-end interface registration capabilities.

In some embodiments, the disclosed techniques involve one or more processors with processing circuitry that perform operations for managing human input during AI agent workflow execution. A user input manager within an AI agent system (or AI agent tool) receives requests for user input from AI agent workflows during their execution. Based on these requests, the user input manager identifies registered callback handlers associated with user interface front-ends from multiple available FEs, where each FE interacts with users through different modalities. The processing circuitry transmits requests for user input to identified user interface front-ends via registered callback handlers, allowing each FE to process requests according to its specific interaction modality and obtain the required user input. The user input manager then routes responses from user interface front-ends back to the requesting AI agent workflows.

During system initialization, the user input manager monitors available user interface front-ends and executes registration processes where each FE provides callback function identifiers. These identifiers are stored in association data structures that map FE types to callback function identifiers. When processing requests, the processing circuitry analyzes them to determine specific input types and generates formatted request messages containing input type specifications and associated parameters before transmitting them to identified user interface front-ends. The processing circuitry handles situations where user interface front-ends cannot support requested input types by detecting compatibility issues, generating error notification messages indicating unsupported input types, and transmitting these notifications back to requesting AI agent workflows. This enables AI agent workflows to continue execution with alternative input request strategies. The available user interface front-ends include command line interfaces, web interfaces, and/or voice input/output interfaces, with the system executing modality-specific interaction protocols for each FE type.

Advanced functionality includes proactive and predictive intervention, where the user input manager decides when human input is necessary without waiting for an explicit request from the agent workflow. The processing circuitry monitors agent workflow execution to determine confidence scores for decision-making processes. When confidence scores fall below predetermined threshold values, the processing circuitry automatically triggers user input requests and integrates user feedback into subsequent agent workflow decision-making processes. The processing circuitry also analyzes AI agent workflow execution patterns to identify repetitive loop behaviors, detecting when AI agent workflows call identical functions with failing arguments. Upon detecting such loops, execution is automatically interrupted by the processing circuitry and user input requests are triggered for clarification or alternative processing directions to save computational resources.

The disclosed techniques include AI-mediated transformation capabilities that convert complex technical requests from AI agent workflows into simpler formats for user interaction. For example, a request from a tool for a structured JSON object with specific keys like “lat” and “lon” can be intercepted by the user input manager and transformed into a natural language query such as “What location are you thinking of?” for the user. This makes the user input manager an active, intelligent participant rather than a simple conduit. This transformation is bidirectional. User responses in simplified or conversational formats (e.g., “somewhere near the big park in the middle of New York”) are processed and converted into structured data formats required by the agent workflows (e.g., a structured JSON object with precise latitude and longitude coordinates). For instance, technical specifications requiring structured data formats can be transformed into natural language queries, making interactions more accessible to users while maintaining the precision needed by the underlying systems. Geographic location handling represents another advanced feature where the processing circuitry analyzes requests to determine when geographic information is needed based on data schema specifications. When the identified user interface front-end supports web-based interactions capable of rendering interactive graphical elements, the processing circuitry generates interactive map user interface components configured to receive geographic coordinate selections from users. These interactive maps are rendered within web-based user interfaces to enable point-and-click selection of desired geographic locations.

Dynamic user interface generation extends the capabilities of the AI agent system by analyzing incoming requests to identify data schema specifications and dynamically generating appropriate user interface components based on these specifications. The processing circuitry renders input widgets including calendar widgets for date inputs, dropdown menus for choice selections, and/or star rating systems for numerical scales, adapting these components to match the specific interaction capabilities and display characteristics of the identified user interface front-end. In some cases, the processing circuitry monitors user interaction history to identify common input patterns and preferences, pre-filling generated interface components with frequently used values or suggestions based on historical usage data. This personalization improves user experience and reduces input time for recurring tasks.

Concurrent operation support allows the system to detect multiple simultaneous requests for user input from different AI agent workflows executing at the same time. A queue data structure manages these concurrent requests in temporal or priority order, processing each request sequentially through registered callback handlers while maintaining proper isolation between different agent workflow contexts.

The disclosed processors can be implemented across various system architectures including control systems for autonomous or semi-autonomous machines, perception systems, simulation operations platforms, digital twin operations systems, light transport simulation systems, collaborative content creation platforms for 3D assets, deep learning operations systems, remote operations platforms, real-time streaming systems, and systems for generating or presenting augmented reality, virtual reality, or mixed reality content. Implementation environments also include edge devices, robotic systems, conversational artificial intelligence operations platforms, multi-modal language models, large language models, small language models, vision language models, synthetic data generation systems, virtual machines, inference microservices, machine learning models deployed in service or microservice configurations with OS-level virtualization packages, data center implementations, and cloud computing resource deployments.

Method implementations follow similar operational patterns, beginning with receiving user input requests from AI agent workflows during execution, identifying registered callback handlers associated with user interface front-ends from multiple available options where each front-end interacts with users through different modalities, transmitting requests to identified front-ends via registered callback handlers for processing according to specific interaction modalities, and routing responses back to requesting AI agent workflows. These methods include comprehensive monitoring, registration, and validation processes that ensure reliable operation across diverse execution environments and user interface configurations.

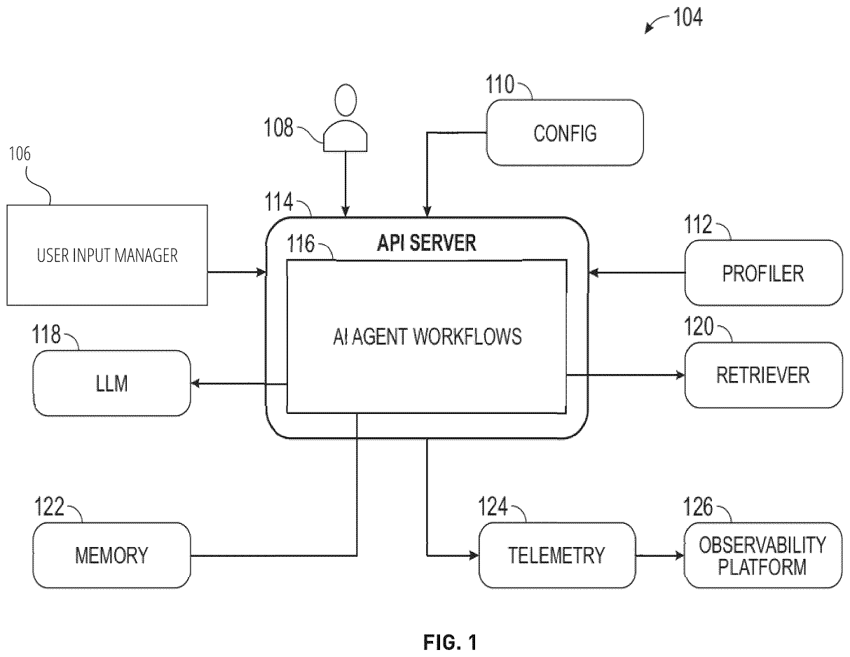

FIG. 1 illustrates a comprehensive AI agent system 104 that enables task-agnostic planning and execution of AI agent workflows 116 through automated user input management across multiple implementation frameworks. It should be understood that this AI agent system 104 shown and described in FIG. 1 and other arrangements described herein are set forth only as examples. Other arrangements and elements (e.g., machines, interfaces, functions, orders, groupings of functions, etc.) may be used in addition to or instead of those shown, and some elements may be omitted altogether. Further, many of the elements described herein are functional entities that may be implemented as discrete or distributed components or in conjunction with other components, and in any suitable combination and location. Various functions described herein as being performed by entities may be carried out by hardware, firmware, and/or software. For instance, various functions may be carried out using one or more processor executing instructions stored in one or more memories. For example, in some embodiments, the system and methods described herein may be implemented using one or more generative language models (e.g., as described below), one or more computing devices or components thereof (e.g., as described below, and/or one or more data centers or components thereof (e.g., as described below).

The AI agent system 104 provides a unified platform for integrating user input management regardless of whether the AI agent workflows 116 are implemented in LangChain, LlamaIndex, CrewAI, Semantic Kernel, and/or other agent frameworks. The architecture supports dynamic function introspection, automatic type conversion, and configuration-driven reasoning wrapper deployment while maintaining compatibility with existing agent development frameworks.

A central component API server 114 serves as the primary interface through which users interact with the AI agent system 104 for user input management. This API server 114 component receives requests from developers seeking to incorporate a user input manager 106 into their AI agent workflows. The API server 114 provides standardized endpoints that allow developers to submit their AI agent workflows 116 for user input management without requiring modifications to their existing agent implementations.

In some embodiments, developers (user 108) may upload their workflows through multiple mechanisms, including direct code submission via REST API endpoints, configuration file uploads using YAML-based workflow definitions, and/or through integration with existing development environments where the API server 114 can access workflow repositories or containerized agent implementations. The API server 114 may implement both manual and/or automated framework detection capabilities to identify which agent frameworks are being used in submitted workflows. For manual detection, developers may explicitly declare the frameworks they are using through configuration parameters or metadata tags when submitting their workflows, such as specifying LangChain, LlamaIndex, CrewAI, Semantic Kernel, or other supported frameworks. The AI agent system 104 may provide standardized configuration templates that allow developers to indicate which frameworks power different components of their multi-framework agent implementations.

For automated framework detection, the API server 114 may coordinate with framework discovery components that inspect source code at build time to identify undeclared agent frameworks. This automated detection process may analyze code structure, library imports, function signatures, and dependency declarations to infer which agent frameworks are being used even when not explicitly declared by developers. The AI agent system 104 may employ pattern matching algorithms that recognize framework-specific coding patterns, API calls, and data structures characteristic of different agent frameworks. Once frameworks are identified through either manual declaration or automated discovery, the API server 114 may coordinate the registration of appropriate custom callback handlers for each detected framework, enabling comprehensive instrumentation and analysis capabilities across heterogeneous agent implementations.

The AI agent workflows 116 may represent the target agent implementations that are being analyzed by the system. These AI agent workflows 116 may be implemented using any combination of supported agent frameworks and may contain complex hierarchies of agents, tools, and other components. The AI agent workflows 116 may include agents built in LangChain that interact with tools developed in LlamaIndex, and/or may consist of single-framework implementations that still benefit from the cross-framework analysis capabilities provided by the system.

A profiler component 112 may perform offline inference performance analysis of the agent workflows by collecting and analyzing execution traces from workflow runs. This profiler may simulate multiple concurrent users interacting with agent workflows to identify performance bottlenecks that only manifest under concurrent load conditions. The profiler component 112 may generate latency analysis reports, conduct bottleneck analysis at the function level, and may identify token efficiency patterns across different stages of agent workflow execution. The profiler component 112 can generate function descriptions of the AI agent workflows 116 for a user input manager 106 to use in managing user input for the AI agent workflows 116.

During operation, the dynamic function inspection capabilities of the AI agent system 104 automatically discover and register functions with input schemas, output schemas, descriptions, and entry points across all supported frameworks. When developers define functions within agent workflows, the system collects function registration data at build time to enable comprehensive understanding of available workflow components. This function registration process occurs transparently without requiring modifications to underlying agent implementations, providing the AI agent system 104 with complete information about tools, agents, and functions that workflows can utilize.

The configuration component 110 may store comprehensive parameters that govern how user input management (e.g., the user input manager 106) operates across different execution environments and FE interfaces. This configuration component 110 can maintain settings that define callback handler registration protocols, specifying how different user interface front-ends establish communication channels with user input managers 106 during system initialization. The configuration component 110 may store mapping relationships between FE types and their corresponding interaction capabilities, enabling the AI agent system 104 to validate compatibility between requested input types and available interface functionalities.

For example, the configuration component 110 may store comprehensive callback handler registration parameters that define precise communication protocols between different FE interfaces and user input managers 106. Namely, the configuration component 110 might maintain a registration table with entries such as: {“frontend_type”: “command_line”, “callback_function”: “cli_input_handler”, “timeout_ms”: 30000, “supported_input_types”: [“confirmation”, “text_input”, “choice_selection”], “max_concurrent_requests”: 1} for command line interfaces, and {“frontend_type”: “web_api”, “callback_function”: “api_input_handler”, “timeout_ms”: 60000, “supported_input_types”: [“confirmation”, “text_input”, “choice_selection”, “geographic_location”, “file_upload”], “max_concurrent_requests”: 10} for web-based interfaces.

In some cases, the configuration component 110 can also store initialization sequences that specify the exact handshake protocols, such as requiring FEs to register within, for example, 5000 milliseconds of system startup and to provide heartbeat signals every 15000 milliseconds to maintain active status. The configuration component 110 may maintain detailed mapping relationships between FE capabilities and input type compatibilities through structured validation matrices. For instance, it might store compatibility mappings like: {“voice_interface”: {“confirmation”: {“supported”: true, “response_format”: “audio_binary”, “max_duration_seconds”: 10}, “geographic_location”: {“supported”: false, “fallback_type”: “text_input”}, “file_upload”: {“supported”: false, “fallback_type”: null}}} and {“web_interface”: {“confirmation”: {“supported”: true, “response_format”: “json”, “ui_component”: “button_group”}, “geographic_location”: {“supported”: true, “response_format”: “coordinates”, “ui_component”: “interactive_map”}, “numerical_rating”: {“supported”: true, “response_format”: “integer”, “ui_component”: “star_rating”, “scale_range”: [1, 5]}}}. These detailed capability matrices enable the AI agent system 104 to perform real-time validation when agent workflows request specific input types, automatically determining whether the active FE can handle the request or if alternative input methods should be suggested.

The configuration component 110 can store advanced operational parameters that govern queue management, error handling, and performance optimization across different execution environments. For example, it might maintain settings such as: {“queue_management”: {“max_pending_requests”: 50, “priority_levels”: [“critical”, “high”, “normal”, “low”], “timeout_escalation”: {“normal”: 45000, “high”: 30000, “critical”: 15000}}, “error_handling”: {“max_retry_attempts”: 3, “retry_delay_ms”: 2000, “fallback_strategies”: [“alternative_input_type”, “simplified_request”, “manual_override”]}, “performance_thresholds”: {“response_time_warning_ms”: 10000, “concurrent_request_limit”: 25, “memory_usage_limit_mb”: 512}}. These configuration parameters enable the user input manager 106 to dynamically adapt its behavior based on system load, FE performance characteristics, and execution context requirements, ensuring robust operation across diverse deployment scenarios while maintaining consistent user experience standards.

In this way, the configuration component 110 can manage timeout parameters that control how long the AI agent system 104 waits for user responses before implementing fallback strategies or error handling procedures. These timeout settings may vary based on the type of input requested, with simple confirmation requests having shorter timeout periods compared to complex data entry tasks that require more user consideration time. The configuration component 110 may also store priority levels for different types of user input requests, enabling the AI agent system 104 to handle multiple concurrent requests in an appropriate order when agents execute simultaneously.

As an example, the configuration component 110 may store timeout parameters with granular specifications that account for the cognitive complexity and expected response time for different categories of user input requests. For example, simple confirmation requests such as “Proceed with file deletion? (Yes/No)” might be configured with shorter timeout periods of 15,000 milliseconds, recognizing that binary decisions typically require minimal deliberation time from users. In contrast, complex data entry tasks requiring substantial user consideration, such as “Please provide detailed project requirements including timeline, budget constraints, and technical specifications,” could be assigned extended timeout periods of 180,000 milliseconds to accommodate the time needed for users to gather information, formulate comprehensive responses, and potentially consult with colleagues or reference materials. The configuration component 110 might also define intermediate timeout levels, such as 45,000 milliseconds for moderately complex requests like “Select your preferred deployment environment from the following options and explain your reasoning,” striking a balance between user convenience and system efficiency.

The priority levels stored in the configuration component 110 enable queue management when multiple concurrent user input requests compete for attention during simultaneous agent execution scenarios. The AI agent system 104 might implement a four-tier priority structure: “critical” for requests involving security approvals or system-affecting decisions with priority level 1 and timeout escalation after 10,000 milliseconds, “high” for workflow-blocking decisions that prevent agent progress with priority level 2 and 30,000 millisecond timeouts, “normal” for standard informational requests with priority level 3 and 60,000 millisecond timeouts, and “low” for optional feedback or enhancement suggestions with priority level 4 and 120000 millisecond timeouts. These priority designations allow the AI agent system 104 to intelligently sequence multiple concurrent requests, ensuring that agents requiring immediate human intervention for critical decisions receive precedence over agents seeking optional input for workflow optimization, thereby preventing high-priority agent workflows from being delayed by lower-importance requests that could be deferred or handled asynchronously.

The configuration component 110 may further store contextual timeout adjustment parameters that dynamically modify base timeout values based on user behavior patterns, system load conditions, and request complexity analysis. For instance, the system might maintain user-specific timeout multipliers, such as extending base timeouts by 1.5× for users who historically require additional consideration time, or reducing timeouts by 0.8× for users with established rapid response patterns. The configuration component 110 could also implement adaptive timeout scaling based on current system load, increasing timeout periods by 25% during peak usage hours when users may be handling multiple concurrent requests, or implementing progressive timeout escalation where initial timeout values automatically extend by 50% if no response is received, allowing users additional time while preventing indefinite blocking of agent workflows.

The user input manager 106 may coordinate the entire flow of human feedback collection by serving as the central orchestration point between agent components and user interface front-ends. This user input manager 106 can receive requests from any point within AI agent workflow execution, whether originating from top-level agent decisions or deeply nested function calls within complex workflow hierarchies. The AI agent system 104 may analyze incoming requests to determine the specific type of human input required, extracting parameters that define the scope and format of information needed from users.

When processing requests, the user input manager 106 can identify the appropriate registered callback handler based on the active FE interface configuration stored in the configuration component 110. The user input manager 106 may validate that the requested input type aligns with the capabilities of the identified FE, implementing graceful error handling when mismatches occur between requested functionality and available interface features. This validation process can prevent system failures and provides informative feedback to requesting agent components about interface limitations.

In some examples, the user input manager 106 may coordinate the entire flow of human feedback collection by implementing compatibility validation mechanisms that analyze the capabilities of registered front-end interfaces against the specific requirements of incoming user input requests from AI agent workflows. This user input manager 106 can receive requests from any point within AI agent workflow execution, whether originating from top-level agent decisions or deeply nested function calls within complex workflow hierarchies. The AI agent system 104 may analyze incoming requests to determine the specific type of human input required, extracting parameters that define the scope and format of information needed from users, such as when an AI agent workflow generates a request for geographic location input with specifications like {“input_type”: “geographic_location”, “required_fields”: [“latitude”, “longitude”], “precision”: “street_level”, “ui_components”: [“interactive_map”, “point_click_selection”]}. When processing requests, the user input manager 106 can identify the appropriate registered callback handler based on the active FE interface configuration stored in the configuration component 110, which maintains detailed capability matrices such as {“command_line”: {“supported_types”: [“confirmation”, “text_input”], “max_concurrent”: 1, “ui_components”: [ ]}, “web_interface”: {“supported_types”: [“confirmation”, “text_input”, “geographic_location”, “file_upload”], “max_concurrent”: 5, “ui_components”: [“calendar”, “dropdown”, “interactive_map”, “rating_stars”]}, “voice_interface”: {“supported_types”: [“confirmation”, “voice_text_input”], “max_concurrent”: 1, “ui_components”: [ ]}}. The user input manager 106 may validate that the requested input type aligns with the capabilities of the identified FE, implementing graceful error handling when mismatches occur between requested functionality and available interface features. For example, when an AI agent workflow requests interactive map functionality for geographic coordinate selection and the user input manager 106 determines that only a command line interface is currently active, the system detects the incompatibility by comparing the request requirements {“input_type”: “geographic_location”, “ui_components”: [“interactive_map”]} against the command line interface capabilities {“supported_types”: [“confirmation”, “text_input”], “ui_components”: [ ]}, identifying that the command line interface lacks support for interactive map components. This validation process can prevent system failures and provides informative feedback to requesting agent components about interface limitations through structured error responses such as {“error”: “unsupported_input_type”, “requested_type”: “geographic_location”, “requested_components”: [“interactive_map”, “point_click_selection”], “active_interface”: “command_line”, “supported_types”: [“confirmation”, “text_input”], “suggested_alternatives”: [“text_based_address_entry”, “coordinate_manual_input”]}.

The user input manager 106 automatically generates these detailed error notifications that enable requesting agent workflows to implement alternative input collection strategies, such as converting the geographic selection request to a text-based prompt like “Please enter the address or coordinates for your desired location” that remains compatible with the command line interface's text input capabilities. Additionally, the system may implement timeout-based fallback detection where the user input manager 106 monitors response times from front-end interfaces and generates compatibility error notifications when interfaces fail to respond within configured timeout periods, such as when a voice interface cannot process complex data schema requests that exceed its natural language processing capabilities, triggering automatic fallback to simpler confirmation-based interaction patterns that maintain workflow continuity while providing appropriate user feedback about interface limitations.

In some examples, the user input manager 106 may coordinate comprehensive request processing workflows by implementing detailed analysis of incoming human input requests and their associated parameters. For instance, when an AI agent workflow 116 generates a request such as {“input_type”: “confirmation”, “message”: “Delete 847 files from project directory?”, “timeout_ms”: 15000, “priority”: “high”}, the user input manager 106 can extract and validate these parameters against available FE capabilities stored in the configuration component 110. The user input manager 106 may process complex data schema requirements, such as when a workflow requests geographic input with specifications like {“input_type”: “geographic_location”, “required_fields”: [“latitude”, “longitude”, “address”], “precision”: “street_level”, “default_region”: “north_America”}, and automatically determine whether the active FE interface supports interactive map rendering or requires fallback to text-based location entry. The user input manager 106 can handle nested workflow scenarios where multiple agent components simultaneously request different input types, such as one component requesting {“input_type”: “numerical_rating”, “scale_range”: [1, 10], “question”: “Rate the solution quality”} while another requests {“input_type”: “choice_selection”, “options”: [“option_a”, “option_b”, “option_c”], “allow_multiple”: false}. The coordination between the user input manager 106 and configuration component 110 enables dynamic validation and routing based on stored capability matrices and interface specifications. The configuration component 110 may maintain detailed front-end capability mappings such as {“command_line”: {“supported_types”: [“confirmation”, “text_input”], “max_concurrent”: 1, “timeout_default”: 30000}, “web_interface”: {“supported_types”: [“confirmation”, “text_input”, “geographic_location”, “file_upload”], “max_concurrent”: 5, “timeout_default”: 60000, “ui_components”: [“calendar”, “dropdown”, “map”, “rating_stars”]}} that allow the user input manager 106 to perform real-time compatibility checking.

When processing requests, the user input manager 106 may implement automatic complexity transformation, converting technical specifications like {“data_format”: “json”, “schema”: {“lat”: “float”, “lon”: “float”}, “validation”: “coordinate_bounds”} into user-friendly requests such as {“display_text”: “Please select your location on the map”, “interaction_mode”: “point_and_click”, “ui_component”: “interactive_map”}. The user input manager 106 can coordinate with the configuration component 110 to implement intelligent error handling, such as when a voice interface front-end returns {“error”: “unsupported_input_type”, “requested”: “geographic_location”, “supported”: [“confirmation”, “text_input”]}, automatically triggering fallback strategies like converting the geographic request to a text-based address entry format.

The user input manager 106 may implement advanced queue management and priority-based processing coordination with the configuration component 110 to handle concurrent execution scenarios across multiple AI agent workflows 116. The manager can process priority-weighted request sequences, such as handling a sequence where {“request_id”: “req_001”, “priority”: “critical”, “confidence_threshold”: 0.3, “agent_id”: “workflow_alpha”} receives immediate processing while {“request_id”: “req_002”, “priority”: “normal”, “confidence_threshold”: 0.7, “agent_id”: “workflow_beta”} enters a managed queue with estimated wait time calculations. The configuration component 110 may store adaptive timeout and escalation parameters like {“priority_escalation”: {“normal_to_high”: 45000, “high_to_critical”: 20000}, “confidence_monitoring”: {“sampling_interval”: 5000, “threshold_adjustment”: 0.1}, “loop_detection”: {“max_iterations”: 3, “similarity_threshold”: 0.95}} that enable the user input manager 106 to implement predictive intervention capabilities. In this way, the user input manager 106 may implement queue management functionality to handle multiple concurrent requests from different agent workflows executing simultaneously. This queuing system can prioritize requests based on urgency levels defined in the configuration component 110, ensuring that time-sensitive decisions receive prompt attention while maintaining orderly processing of routine input requests. The user input manager 106 can track the status of pending requests and provide progress updates to waiting agent components.

This coordination allows the system to automatically detect execution patterns such as repetitive tool calls with arguments [{“tool”: “data_analyzer”, “args”: {“dataset”: “sales_q3”, “method”: “linear”}}, {“tool”: “data_analyzer”, “args”: {“dataset”: “sales_q3”, “method”: “polynomial”}}, {“tool”: “data_analyzer”, “args”: {“dataset”: “sales_q3”, “method”: “exponential”}}] and trigger human intervention requests with contextual information about the detected loop behavior and suggested alternative approaches. For example, the user input manager 106 implements loop detection algorithms that continuously monitor agent workflow execution patterns to identify when agents become trapped in repetitive, failing sequences that indicate decision-making difficulties or resource inefficiencies. For example, when an agent attempts to analyze a dataset, it might repeatedly call a data\_analyzer tool with progressively modified but fundamentally similar arguments such as {“dataset”: “sales\_q3\_2024”, “method”: “linear\_regression”, “confidence”: 0.8}, followed by {“dataset”: “sales_q3\_2024”, “method”: “polynomial\_regression”, “confidence”: 0.7}, then {“dataset”: “sales\_q3\_2024”, “method”: “exponential\_regression”, “confidence”: 0.6}, with each call returning error responses or low-quality results that fail to meet the agent's success criteria. The AI agent system 104 maintains execution traces that track function call patterns, argument similarity scores, and response quality metrics, enabling the user input manager 106 to calculate repetition thresholds based on configurable parameters such as maximum iterations (e.g., set to 3-5 attempts), argument similarity coefficients (e.g., 0.85-0.95 similarity indicating near-identical calls), and/or failure rate patterns that suggest the agent is not making meaningful progress toward its objectives.

When the loop detection system of the user input manager 106 identifies these repetitive patterns, the user input manager 106 automatically implements interruption protocols that pause the agent's execution before it wastes additional computational resources or potentially enters infinite loops that could destabilize the entire workflow. The interruption mechanism generates contextual user intervention requests that include comprehensive information about the detected loop behavior, such as a detailed summary showing “Agent attempted 4 consecutive calls to data\_analyzer with similar parameters: attempts 1-3 failed with error ‘insufficient\_data\_correlation’ and attempt 4 achieved only 23% confidence score, which falls below the 75% threshold.” The user input manager 106 presents users with specific alternative approaches based on the failure analysis, such as suggesting “Would you like me to: (A) try a different analysis method like clustering or decision trees, (B) request additional data sources to improve correlation, or (C) modify the confidence threshold requirements?” This intelligent intervention prevents agents from consuming excessive resources while providing users with actionable options to guide the workflow toward successful completion, demonstrating a level of adaptive problem-solving that distinguishes this approach from simple timeout mechanisms or basic error handling found in traditional application architectures.

The predictive intervention capabilities extend beyond simple repetition detection to include confidence-based triggering mechanisms where the user input manager 106 monitors agent decision-making confidence scores and automatically requests human guidance when confidence levels drop below predetermined thresholds during critical workflow operations. For instance, when an agent evaluating financial data for investment recommendations generates confidence scores that progressively decline from 0.89 to 0.67 to 0.41 across successive analysis steps, the user input manager 106 recognizes this pattern as indicating increasing uncertainty and automatically pauses execution to request human oversight with messages like “My confidence in this investment analysis has dropped to 41% due to conflicting market indicators-should I proceed with the current approach or would you prefer to review the methodology?” This proactive intervention capability enables the user input manager 106 to prevent poor decisions before they occur rather than merely reacting to failures after the fact, creating a collaborative human-AI workflow where the system intelligently determines when human expertise is most valuable for maintaining workflow quality and achieving optimal outcomes.

The user input manager 106 can perform AI-mediated transformation of complex technical requests into user-friendly formats that improve human comprehension and response quality. When agents generate requests containing technical specifications or structured data requirements, the user input manager 106 may convert these into natural language questions that users can easily understand and respond to appropriately. This transformation capability enables seamless interaction between highly technical agent processes and human users who may not possess specialized domain knowledge. For instance, when an AI agent workflow requires geographic coordinates for a mapping operation, instead of presenting the user with a complex technical specification such as “Please provide a JSON object containing latitude and longitude coordinates in decimal degree format with precision to six decimal places, ensuring values fall within valid ranges of −90 to 90 for latitude and −180 to 180 for longitude,” the user input manager 106 can transform this into an intuitive natural language query like “What location are you thinking of?” or “Where would you like me to focus this analysis?” The transformation process involves parsing the technical data schema requirements, identifying the core information need, and generating contextually appropriate questions that maintain the precision requirements while eliminating technical jargon that could confuse or overwhelm users who lack specialized knowledge in coordinate systems or data formatting standards.

The bidirectional transformation capabilities of the user input manager 106 extend to processing user responses and converting them back into the structured formats required by the requesting AI agent workflows. When a user provides a conversational response such as “I dunno, maybe somewhere near the big park in the middle of New York?” the user input manager 106 can leverage natural language understanding algorithms to parse the informal description, resolve geographic references like “the big park in the middle of New York” to Central Park coordinates, and generate the precise JSON object containing latitude: 40.7829, longitude: −73.9654 that the original agent workflow requires. This intelligent mediation ensures that technical agent processes receive properly formatted data while users can interact using natural, conversational language patterns without needing to understand the underlying technical specifications or data structure requirements that drive the agent's functionality.

Namely, the response processing capabilities of the user input manager 106 may include converting user-provided information back into structured data formats required by requesting agent components. The user input manager 106 can parse conversational responses from users and extract relevant data points, formatting them according to the specifications originally requested by agent workflows. This bidirectional transformation ensures that human input integrates smoothly with automated agent processes regardless of the complexity difference between user communication styles and technical system requirements.

The user input manager 106 may implement dynamic user interface generation capabilities that create appropriate input widgets based on the data schema specifications provided by requesting agents. When agents require specific types of information such as dates, geographic locations, or numerical ratings, the manager can generate corresponding interface elements like calendar widgets, interactive maps, or rating systems. These dynamically generated interfaces can adapt to the capabilities and characteristics of the active front-end platform.

Geographic location handling represents a specialized capability where the user input manager 106 can detect when spatial information is required and generate interactive map components for web-based interfaces. The user input manager 106 may coordinate with mapping services to provide point-and-click selection capabilities that allow users to specify locations precisely without requiring manual coordinate entry. For non-graphical interfaces, the manager can implement alternative location specification methods appropriate to the interface capabilities.

For example, when an AI agent workflow requires temporal information with a data schema specification such as {“input_type”: “date_selection”, “format”: “ISO_8601”, “constraints”: {“min_date”: “2025 Jan. 1”, “max_date”: “2026 Dec. 31”}}, the user input manager 106 can dynamically generate appropriate date selection interfaces based on the active front-end capabilities. For web-based interfaces, the user input manager 106 may render interactive calendar widgets with date range restrictions, month navigation controls, and visual indicators for valid selection periods, while for command-line interfaces, the user input manager 106 could generate text-based date prompts with format validation such as “Enter date (YYYY-MM-DD) between 2025 Jan. 1 and 2026 Dec. 31:” that provide immediate feedback on input formatting and constraint compliance.

The user input manager 106 can process complex rating schema requirements like {“input_type”: “numerical_rating”, “scale_type”: “likert”, “range”: [1, 10], “labels”: {“1”: “Poor”, “5”: “Average”, “10”: “Excellent”}, “allow_decimals”: false} and generate contextually appropriate rating interfaces. For graphical front-ends, this might involve creating interactive star rating systems, slider controls with labeled tick marks, or button arrays with descriptive text labels, while voice interfaces could implement spoken rating collection with confirmation prompts such as “Please rate from 1 to 10, where 1 is Poor and 10 is Excellent” followed by “You selected 7, is this correct?” When agents specify file input requirements through schemas like {“input_type”: “file_upload”, “accepted_formats”: [“.pdf”, “.docx”, “.txt”], “max_size_mb”: 50, “multiple_files”: true, “validation_required”: true}, the user input manager 106 can generate file handling interfaces that adapt to FE capabilities. Web interfaces might display drag-and-drop file upload zones with progress indicators, file type validation, and thumbnail previews, while API-based front-ends could generate secure file upload endpoints with proper MIME type checking and size validation, and command-line interfaces might implement file path prompts with tab completion and batch file selection support.

In some cases, the user input manager 106 can handle complex decision-making scenarios when provided with schemas such as {“input_type”: “multi_choice”, “selection_mode”: “single”, “options”: [{“id”: “opt1”, “label”: “Process immediately”, “description”: “Begin processing now with current settings”}, {“id”: “opt2”, “label”: “Schedule for later”, “description”: “Set a specific time for processing”}], “allow_custom”: false}. For graphical interfaces, this could generate radio button groups with expandable descriptions, dropdown menus with hover tooltips, or card-based selection layouts with visual icons, while text-based interfaces might create numbered lists with detailed option descriptions and input validation to ensure only valid selections are accepted.

Geographic location handling represents a specialized capability where the user input manager 106 can detect when spatial information is required and generate interactive map components for web-based interfaces. The user input manager 106 may coordinate with mapping services to provide point-and-click selection capabilities that allow users to specify locations precisely without requiring manual coordinate entry. For non-graphical interfaces, the user input manager 106 can implement alternative location specification methods appropriate to the interface capabilities.

The user input manager 106 may maintain user interaction history to identify patterns and preferences that improve future interaction efficiency. This historical analysis can enable the manager to pre-populate interface elements with frequently used values or suggest likely responses based on previous user behavior in similar contexts. The personalization capabilities can reduce user effort and improve response accuracy while maintaining privacy and user control over stored information. For example, when a data analysis agent repeatedly requests geographic location input for market research projects, the user input manager 106 could maintain records showing that a particular user consistently selects locations within the Pacific Northwest region, specifically focusing on major metropolitan areas like Seattle, Portland, and Vancouver. The user input manager 106 analyzes these historical patterns and builds a preference profile indicating that when this user encounters geographic selection requests in business analysis contexts, they have an 85% likelihood of selecting urban areas within a specific geographic region, typically choosing locations with populations exceeding 500,000 people.

When future AI agent workflows request geographic input from this same user, the user input manager 106 can leverage this historical analysis to dramatically improve interaction efficiency through intelligent pre-population and suggestion mechanisms. The user input manager 106 might automatically generate an interactive map interface that is pre-centered on the Pacific Northwest region with major metropolitan areas already highlighted as suggested options, rather than presenting a blank world map that requires extensive navigation. Additionally, the user input manager 106 could populate dropdown location lists with the user's five most frequently selected cities at the top of the selection menu, followed by other major metropolitan areas in their preferred geographic region, significantly reducing the time required for the user to locate and select their intended location. The user input manager 106 maintains granular preference data such as the user's tendency to prefer coastal cities over inland locations (78% historical preference), their preference for selecting locations during specific times of day (afternoon selections tend toward West Coast cities, morning selections toward East Coast cities), and their contextual patterns where financial analysis requests typically result in major financial center selections while demographic research requests lead to more diverse geographic distribution.

The personalization capabilities extend beyond simple pre-population to include intelligent response suggestion that adapts to the user's communication style and decision-making patterns while maintaining strict privacy controls and user autonomy. The user input manager 106 might detect that a particular user consistently provides detailed explanatory text when responding to confirmation requests, typically including 2-3 sentences of justification rather than simple yes/no responses. In future interactions, the user input manager 106 could automatically expand text input fields to accommodate this user's communication style and provide pre-filled suggestion templates such as “Yes, I approve this action because . . . ” or “No, I prefer an alternative approach such as . . . ” that align with their historical response patterns. The privacy protection mechanisms ensure that user preference data remains encrypted and compartmentalized, with users maintaining granular control over which types of interaction history are stored, how long data is retained (with automatic expiration options ranging from 30 days to 2 years), and the ability to selectively delete preference categories or completely reset their personalization profile at any time. Users can also configure privacy modes where certain types of sensitive interactions (such as financial approvals or security-related confirmations) are excluded from historical analysis, ensuring that personalization improvements never compromise security or privacy requirements while still providing efficiency benefits for routine, non-sensitive workflow interactions.

Error handling and resilience features of the user input manager 106 may include comprehensive failure recovery mechanisms that maintain agent workflow continuity even when user input collection encounters problems. The user input manager 106 can implement retry logic for failed requests, alternative input method suggestions when primary interfaces become unavailable, and graceful degradation strategies that allow agents to continue execution with modified parameters when human input cannot be obtained.

The user input manager 106 can coordinate with the observability platform 126 shown in FIG. 1 to provide comprehensive logging and monitoring of human-in-the-loop interactions. This coordination may enable developers to analyze patterns in user input requests, identify bottlenecks in human feedback collection, and optimize agent workflows based on actual user interaction data. The manager can generate metrics about response times, input quality, and interface effectiveness.

Integration capabilities of the user input manager 106 may extend to coordination with the telemetry component 124 for performance monitoring and the memory component 122 for context preservation during extended user interaction sessions. The user input manager 106 can ensure that agent context remains intact during potentially lengthy human input collection processes, preventing loss of workflow state that could require restart or repetition of previous processing steps.

The user input manager 106 may implement confidence scoring mechanisms that work in conjunction with agent decision-making processes to determine when human input becomes necessary. The user input manager 106 can monitor agent confidence levels and automatically trigger user input requests when confidence falls below predetermined thresholds defined in the configuration component 110. This proactive approach can prevent agents from proceeding with uncertain decisions while maintaining workflow momentum.

The user input manager 106 can support extensible interaction types beyond basic confirmation and question-answer patterns, allowing developers to define custom interaction modes specific to their application requirements. The user input manager 106 may provide frameworks for implementing specialized input collection workflows such as multi-step wizards, approval chains, or collaborative decision-making processes that involve multiple human participants. For instance, when an AI agent workflow requires configuration of a complex deployment environment, the user input manager 106 could orchestrate a multi-step wizard beginning with infrastructure selection where the user chooses between cloud providers

(AWS, Azure, GCP), followed by resource specification where users define compute requirements (CPU cores, memory allocation, storage capacity), then network configuration where users specify security groups and access policies, and finally validation where users review and confirm their complete configuration before the agent workflow proceeds with deployment. The user input manager 106 maintains a persistent state object throughout this process, such as {“step”: 3, “infrastructure”: {“provider”: “aws”, “region”: “us-east-1”}, “resources”: {“cpu_cores”: 8, “memory_gb”: 32}, “network”: {“vpc_id”: “vpc-12345”, “security_groups”: [“sg-web”, “sg-db”]}, “validation_pending”: true}, enabling the user input manager 106 to handle interruptions, allow users to navigate backward through previous steps, and maintain complete context even if the underlying agent workflow execution spans extended time periods.

The user input manager 106 may coordinate complex approval workflows that involve multiple stakeholders with different roles and permissions, implementing routing logic that ensures proper authorization sequences while maintaining agent workflow execution integrity. When an AI agent workflow requests approval for a high-value financial transaction, the user input manager 106 could implement a hierarchical approval chain where the initial request routes to a department manager for preliminary approval with a 24-hour timeout, followed by automatic escalation to a finance director for budget validation with specific spending thresholds (amounts over $10,000 require director approval, amounts over $50,000 require CFO approval), then final routing to compliance review for regulatory verification if the transaction involves international transfers or regulated industries. The system maintains detailed audit logs throughout this process, tracking {“approval_chain_id”: “AC-2025-001”, “initiating_agent”: “procurement_workflow_v2”, “current_step”: 2, “approvals”: [{“approver”: “dept_manager_smith”, “decision”: “approved”, “timestamp”: “2025-09-03T10: 15:30Z”, “conditions”: “requires_compliance_review”}], “pending_approvers”: [“finance_director_jones”, “compliance_team”], “timeout_escalations”: {“director_approval”: “2025-09-04T10: 15:30Z”, “cfo_escalation”: “2025-09-06T10: 15:30Z”}}, ensuring complete traceability and enabling the agent workflow to resume execution only after all required approvals are obtained.

The user input manager 106 may facilitate collaborative decision-making processes where multiple human participants contribute expertise, debate alternatives, and reach consensus before the agent workflow continues execution. For complex technical architecture decisions, the user input manager 106 could orchestrate a collaborative session where different domain experts provide input simultaneously or asynchronously, such as when an AI agent workflow needs to select optimal database technologies for a new application. The user input manager 106 could route the decision request to multiple specialists including a database administrator who provides performance requirements and scalability constraints, a security engineer who specifies compliance and encryption requirements, a DevOps engineer who outlines deployment and maintenance considerations, and a solutions architect who evaluates cost implications and integration complexity. The user input manager 106 coordinates these parallel inputs using structured data collection such as {“collaboration_session”: “db_selection_2025_q3”, “participants”: [{“role”: “dba”, “user”: “alice_db”, “input_status”: “completed”, “recommendations”: [“postgresql_primary”, “redis_cache”], “constraints”: [“max_latency_5 ms”, “99.99_uptime”]}, {“role”: “security”, “user”: “bob_sec”, “input_status”: “pending”, “requirements”: [“encryption_at_rest”, “rbac_integration”]}], “decision_matrix”: {“criteria”: [“performance”, “security”, “cost”, “maintainability”], “weighted_scores”: {“postgresql”: 8.5, “mongodb”: 7.2, “cassandra”: 6.8}}, “consensus_threshold”: 0.75, “final_decision”: null}, enabling the agent workflow to receive comprehensive multi-perspective analysis before making technical decisions that affect the entire system architecture.

Scalability features of the user input manager 106 may include load balancing capabilities that distribute user input requests across multiple interface instances when dealing with high-volume agent deployments. The user input manager 106 can coordinate with resource management systems to ensure adequate response capacity during peak usage periods while maintaining response time guarantees for different classes of input requests.

The user input manager 106 may implement security and access control mechanisms that ensure appropriate authorization for different types of human input requests. The user input manager 106 can validate user permissions before presenting sensitive information or critical decision points, implementing role-based access controls that align with organizational security policies. These security features can prevent unauthorized access to agent workflows while maintaining usability for legitimate users.

The user input manager 106 can provide comprehensive API interfaces that enable integration with external systems and third-party tools that may serve as additional front-end options. These API capabilities may allow the system to extend beyond traditional user interfaces to include integration with business process management systems, workflow orchestration platforms, or specialized domain-specific tools that provide context-appropriate human input collection mechanisms tailored to specific industry requirements.

FIG. 1 further shows a language model 118 and memory 122. The language model 118 may represent language model integrations that are monitored and analyzed by the AI agent system 104. The system may track LM inference requests, measure response times, and may analyze token utilization patterns for prompt tokens versus completion tokens. The language model 118 analysis may help developers understand the efficiency of their language model usage and may identify opportunities for prompt reduction or caching. The language model 118 may be incorporated at least in part into the user input manager 106.

The memory 122 component may represent conversation history and context management operations that support the separation of planning and execution phases in AI agent workflows. This memory 122 can maintain persistent state information across extended user interaction sessions, ensuring that agent workflow context remains intact during potentially lengthy human input collection processes that might otherwise result in loss of execution state or require restart of previous processing steps. The memory 122 may store detailed interaction histories that enable the user input manager 106 to provide contextual information when generating user input requests, allowing human users to understand the broader workflow context surrounding specific input requests and make more informed decisions based on previous interaction patterns and agent execution history.

The memory 122 can implement sophisticated caching mechanisms that preserve agent workflow state during human input collection operations, maintaining variables, function call stacks, and execution context while the user input manager 106 processes requests for human feedback. This state preservation capability enables seamless resumption of agent workflow execution after human input has been collected and processed, preventing the loss of computational work or the need to regenerate previous results when workflows require human intervention at arbitrary points during execution. The memory 122 may coordinate with the user input manager 106 to implement checkpoint and recovery mechanisms that allow agent workflows to resume from precise execution points after human input collection, maintaining consistency between pre-intervention and post-intervention workflow states.

The memory 122 may store user preference profiles and interaction patterns that enable the user input manager 106 to customize human input collection strategies based on historical user behavior and response characteristics. This personalization capability allows the system to adapt request formatting, timeout parameters, and interface selection based on user-specific patterns such as response time preferences, favored input modalities, and typical decision-making approaches for different types of workflow requests. The memory 122 can maintain granular records of user interaction efficiency metrics, enabling the user input manager 106 to optimize future human input collection processes by pre-selecting interface configurations and request formats that align with individual user preferences and demonstrated effectiveness patterns.

The conversation history management capabilities of the memory 122 may include maintaining threaded conversation contexts that span multiple human input collection cycles within single agent workflow executions. When workflows require multiple rounds of human feedback or iterative refinement through human-in-the-loop processes, the memory 122 can preserve conversational context that enables the user input manager 106 to provide coherent, contextually appropriate follow-up requests that reference previous interactions and build upon established communication patterns. This conversational continuity ensures that users receive sufficient context to make informed decisions throughout extended collaborative sessions between human users and agent workflows.

Advanced context management features of the memory 122 may include semantic analysis of workflow execution traces that enable intelligent context summarization for human input requests. When the user input manager 106 requires human feedback for complex workflow decisions, the memory 122 can analyze previous execution steps to generate concise, relevant context summaries that provide users with appropriate background information without overwhelming them with excessive technical details. This context intelligence enables more effective human decision-making by presenting workflow history in formats that align with human cognitive processing patterns while maintaining sufficient technical precision for informed feedback.

The memory 122 may coordinate with the configuration component 110 to implement adaptive timeout and retry policies based on historical human response patterns and workflow execution characteristics. By analyzing previous human input collection sessions stored in memory, the system can automatically adjust timeout parameters, retry strategies, and escalation procedures based on demonstrated user behavior patterns and workflow complexity factors. This adaptive approach enables the user input manager 106 to optimize human input collection efficiency while accommodating varying user availability and decision-making timeframes across different types of workflow requests.

A retriever component 120 may represent retrieval operations and tools that can be dynamically inspected by the AI agent system 104 for inclusion in reasoning-generated execution plans. The AI agent system 104 may automatically discover retriever functions through function registration data, collecting their input schemas, output schemas, descriptions, and entry points to enable comprehensive understanding of available retrieval capabilities. This retriever component 120 can coordinate with the user input manager 106 to enhance human input collection processes by providing contextual information that supports more informed human decision-making during workflow execution.

The retriever component 120 may implement intelligent information gathering capabilities that automatically supplement human input requests with relevant contextual data retrieved from external knowledge sources, databases, or previous workflow executions. When the user input manager 106 processes requests for human feedback, the retriever component 120 can automatically identify and fetch related information that may influence human decision-making, presenting this contextual data alongside the original input request to enable more comprehensive evaluation of available options. This automatic context enrichment reduces the cognitive burden on human users while improving the quality of human feedback by ensuring that decisions are made with access to complete relevant information.

The retriever component 120 can provide dynamic knowledge base access that enables the user input manager 106 to answer user questions or provide clarifications during human input collection processes. When users require additional information to make informed decisions about agent workflow requests, the retriever component 120 can search relevant documentation, previous execution logs, or external data sources to provide immediate answers without requiring workflow interruption or manual research by human users. This just-in-time information access capability enhances the efficiency of human-in-the-loop processes by reducing the time required for users to gather necessary background information.

Advanced retrieval capabilities of the retriever component 120 may include semantic search and similarity matching that enables the user input manager 106 to present users with relevant examples from previous workflow executions or similar decision scenarios. When human users encounter unfamiliar or complex workflow decisions, the retriever component 120 can identify analogous situations from historical execution data and present these examples as reference points for current decision-making. This precedent-based guidance system helps users make consistent decisions across similar scenarios while reducing the learning curve associated with complex workflow interactions.

The retriever component 120 may implement real-time data access capabilities that enable the user input manager 106 to present users with current information relevant to workflow decision points. For workflows that depend on time-sensitive data such as market conditions, system status, or resource availability, the retriever component 120 can automatically fetch current data and present it alongside human input requests to ensure that decisions are made based on up-to-date information. This real-time data integration capability ensures that human feedback reflects current conditions rather than potentially outdated assumptions or cached information.

Collaborative retrieval features of the retriever component 120 may enable the user input manager 106 to access shared knowledge repositories that contain insights and decisions from other users who have encountered similar workflow scenarios. When multiple users interact with similar agent workflows over time, the retriever component 120 can build shared knowledge bases that capture effective decision patterns, common pitfalls, and recommended approaches for different types of workflow situations. This collaborative intelligence enables new users to benefit from collective experience while maintaining individual decision-making autonomy.

The retriever component 120 can implement predictive information gathering that anticipates information needs based on workflow execution patterns and user behavior analysis. By analyzing previous human input collection sessions and workflow outcomes, the retriever component 120 can pre-fetch information that is likely to be relevant for upcoming decision points, reducing latency when users request additional context during workflow execution. This predictive approach enables more responsive human input collection processes by ensuring that relevant information is readily available when needed.

Integration capabilities of the retriever component 120 may extend to external API access that enables the user input manager 106 to gather real-time information from third-party services and systems relevant to workflow decision-making. When agent workflows interact with external systems or require decisions based on external data sources, the retriever component 120 can automatically access these systems to provide current information to human users, ensuring that workflow decisions are made with access to comprehensive and current data from all relevant sources.

The retriever component 120 may coordinate with the telemetry component 124 to provide performance analytics that inform human decision-making about workflow optimization and resource allocation strategies. When users make decisions about workflow configuration, resource allocation, or optimization approaches, the retriever component 120 can provide relevant performance metrics, historical execution data, and comparative analysis that enables data-driven decision-making. This performance-informed approach enables users to make workflow decisions based on empirical evidence rather than assumptions or incomplete information.

Quality assurance features of the retriever component 120 may include information validation and reliability assessment that ensures the user input manager 106 presents users with accurate and trustworthy contextual information. The retriever component 120 can implement validation mechanisms that assess the currency, accuracy, and relevance of retrieved information before presenting it to users, preventing decision-making based on outdated or incorrect data. This information quality assurance ensures that human input collection processes maintain high standards of decision-making support while building user confidence in the provided contextual information.

In some examples, metadata from all components may be normalized across different frameworks into a unified data model that gets published to an intermediate step stream. This normalization process may be enabled by the AI agent system's approach of wrapping individual functions with standardized input schemas, output schemas, and descriptions, regardless of whether those functions represent agents, tools, LLMs, or other workflow components. By wrapping each function in this standardized interface, the AI agent system may create a common abstraction layer that allows framework-specific data structures to be converted into the unified data model. This function wrapping mechanism may ensure that LLM events, tool events, and other workflow events appear identical regardless of their originating framework, since all wrapped functions conform to the same standardized format with defined inputs, outputs, and descriptions. The standardized intermediate step stream may enable consistent analysis capabilities across heterogeneous agent implementations because the wrapped functions provide a framework-agnostic foundation for data collection and normalization.

For example, the metadata normalization process operates by taking framework-specific data structures and converting them into a standardized intermediate representation that maintains semantic consistency across all supported agent frameworks. Namely, when a LangChain agent makes an LLM call, the callback handler extracts metadata that might include LangChain-specific fields such as: langchain.schema.messages.AIMessage; objects with nested content; and additional_kwargs fields, alongside timing data in LangChain's proprietary format. Simultaneously, when a LlamaIndex agent performs a similar LLM operation, its callback handler captures metadata in LlamaIndex's native format, which could include: llama_index.core.base.llms.types. ChatMessage objects with different field structures and timestamp representations. The normalization engine then transforms both of these disparate data structures into a unified format that includes standardized fields such as: input_text, output_text, prompt_tokens, completion_tokens, latency_ms, timestamp_iso, and function_ancestry, ensuring that an LLM call appears identical regardless of whether it originated from LangChain, LlamaIndex, CrewAI, or any other supported framework.

The intermediate step stream serves as the central nervous system for this standardized data flow, implementing a reactive publisher-subscriber architecture that maintains event ordering and hierarchy relationships across framework boundaries. When normalized metadata events are published to the stream, they can include enriched contextual information such as parent-child function relationships, execution depth levels, and cross-framework correlation identifiers that enable comprehensive workflow analysis. For instance, if an agent workflow begins with a LangChain ReAct agent that calls a LlamaIndex retriever tool, which subsequently invokes a CrewAI sub-agent, the intermediate step stream maintains a complete ancestry chain showing how langchain_react_agent.execute( ) called llamaindex_retriever.search( ) which then called crewai_specialist.analyze( ) Each event in the stream contains standardized metadata fields including execution timestamps (e.g., start_time: 2025-01-15T14:30:25.123Z), token utilization metrics (e.g., prompt_tokens: 1247, completion_tokens: 389), and performance indicators (e.g., execution_duration_ms: 2340), enabling downstream subscribers to perform consistent analysis regardless of the underlying framework complexity.

A telemetry component 124 may collect and manage performance metrics generated during workflow analysis. This telemetry component 124 may gather timing data, resource utilization statistics, and workflow execution traces that enable comprehensive performance characterization. The telemetry component 124 may support multiple subscriber types that can access the telemetry data for different purposes including profiling, evaluation, and observability. The telemetry component 124 can be used by the profiler component 112 to generate function descriptions and behavior information about the AI agent workflows 116 to feed back to the user input manager 106 to generate updated execution plans.

An observability platform 126 component may receive exported trace data in OpenTelemetry-compatible formats for visualization and monitoring purposes. The AI agent system 104 may convert intermediate steps into framework-specific visualization formats that work with different observability tools. This capability may enable cross-framework observability where agents built in one framework can be visualized using tools associated with different frameworks.

The results generated by the AI agent system 104 may be output in standardized formats that enable developers to identify workflow performance characteristics and behavioral insights. These outputs may include performance efficiency metrics, bottleneck analysis reports, and token utilization patterns that help developers make informed decisions about agent workflow deployment and resource allocation. The standardized output format may ensure compatibility with various development tools and may facilitate integration with existing development workflows.

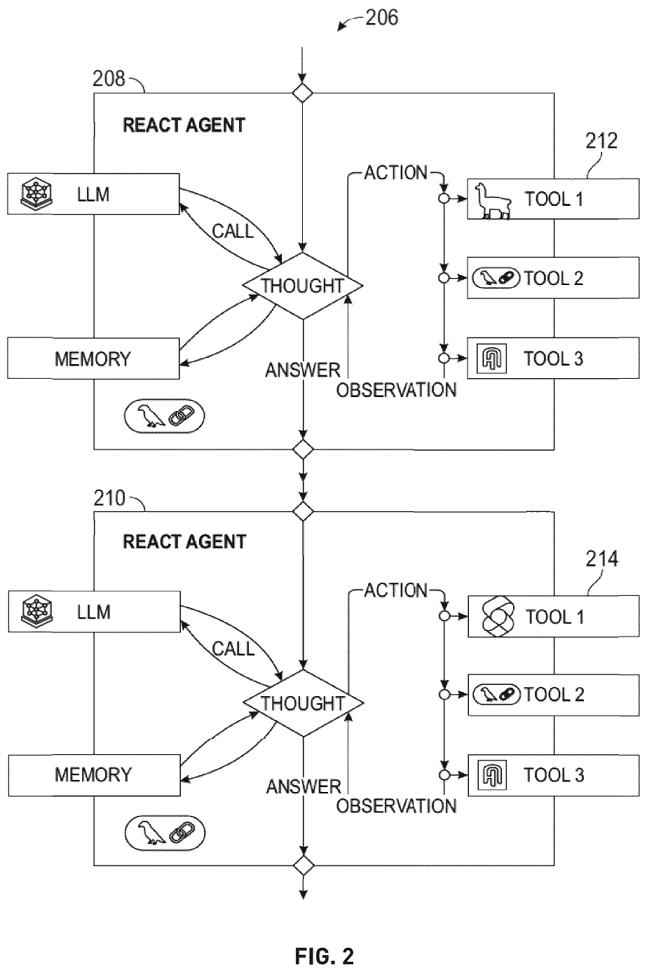

FIG. 2 illustrates the human feedback collection capabilities of the AI agent system 104, according to at least some embodiments of the present disclosure, demonstrating how multiple AI agent workflows created using different frameworks can be seamlessly enhanced with universal user input management through automated callback handler registration using the user input manager 106. The AI agent workflow diagram 206 shows two distinct ReAct agent implementations that can be coordinated by the user input manager 106 to enable context-agnostic human feedback collection across heterogeneous execution environments while maintaining compatibility with existing agent development frameworks.

A first AI agent workflow 208 represents a ReAct agent implementation that can request human input at any point during its execution cycle through the user input manager 106. This first AI agent workflow 208 contains an LLM component that follows the standard ReAct reasoning pattern of Thought->Action->Observation, with Memory components maintaining conversation context throughout the interaction cycle. The user input manager 106 enables any component within this workflow to pause execution and request human feedback without requiring modifications to the underlying ReAct implementation or knowledge of the deployment environment.

A first set of tools 212 associated with the first AI agent workflow 208 includes Tool 1, Tool 2, and Tool 3, each of which can independently access the user input manager 106 to request human input during their execution. The user input manager 106 automatically provisions context-specific access to these tools, enabling them to generate user input requests such as confirmations, data entry, or approval workflows without requiring knowledge of which front-end interface is active. When any tool within this first set of tools 212 requires human intervention, the user input manager 106 identifies the appropriate registered callback handler based on the active FE configuration and routes the request through the established communication protocols.

A second AI agent workflow 210 demonstrates the system's ability to provide consistent user input management across different agent implementations that may utilize entirely different frameworks from the first workflow. This second ReAct agent contains its own LLM and Memory components following the identical Thought->Action->Observation pattern while maintaining complete independence from the first workflow. The user input manager 106 provides framework-agnostic human feedback collection capabilities, enabling this second agent to request human input using the same standardized interface regardless of its underlying implementation framework or deployment context.

A second set of tools 214 associated with the second AI agent workflow 210 includes Tool 1, Tool 2, and Tool 3, which operate independently from the first set of tools 212 but access the same user input manager 106 infrastructure for human feedback collection. The user input manager 106 maintains complete isolation between the two agent workflows while providing consistent human input collection capabilities across both tool sets. Each tool in the second set of tools 214 can generate user input requests that are processed through the same callback handler registration system, ensuring uniform user interaction patterns regardless of which agent workflow initiates the request.

The automatic FE adaptation capabilities enable seamless integration between different user interface modalities and the input requirements of both agent workflows. When either workflow generates requests for human input, the user input manager 106 automatically identifies the active FE interface and adapts the request format to match the specific interaction capabilities of that interface. This adaptation occurs transparently across both the first AI agent workflow 208 and second AI agent workflow 210, regardless of their framework implementations or tool configurations, ensuring consistent user experience across different execution environments.

The configuration-driven callback handler registration allows developers to deploy either or both agent workflows with human-in-the-loop capabilities through simple front-end interface registration during system initialization. Users can connect multiple front-end interfaces such as command line terminals, web-based interfaces, or voice input systems to the same agent workflows, with the user input manager 106 automatically routing requests to the active interface. This configurability enables flexible deployment scenarios where human feedback collection can be adapted to different user preferences and execution contexts without requiring code modifications to existing agent implementations.

The human feedback collection process for both workflows involves receiving user input requests from any component within the agent execution hierarchy, identifying registered callback handlers associated with available front-end interfaces, and transmitting formatted requests through the appropriate communication channels. The user input manager 106 provides standardized request routing that enables consistent human interaction patterns while maintaining the separation between agent logic operations and execution context dependencies performed by the underlying ReAct agents.

The AI agent workflow diagram 206 illustrates how the AI agent system's user input management abstractions enable complex multi-agent scenarios where different agents built using different frameworks can request human feedback as part of a unified system. This capability allows developers to leverage the efficiency gains from execution context abstraction and automated request routing while maintaining comprehensive configurability and cross-framework compatibility across their entire agent ecosystem.

For example, when the first AI agent workflow 208 encounters a decision point requiring human approval during a complex data analysis task, any component within the workflow can request user confirmation through the user input manager 106. The request might be formatted as: “Tool 1 requires approval to delete 847 files from the project directory-proceed? (Yes/No)” and the user input manager 106 automatically routes this to the active FE interface, whether that's a command line prompt, web-based dialog box, or voice confirmation system. The user input manager 106 handles the response processing and returns the formatted result back to the requesting tool, enabling the first AI agent workflow 208 to continue execution based on the human decision without any knowledge of which interface was used to collect the input.

For the second AI agent workflow 210 that includes the second set of tools 214, when processing concurrent operations that require different types of human input simultaneously, the user input manager 106 coordinates multiple request types through queue management and priority handling. For instance, Tool 2 might request geographic location selection while Tool 3 simultaneously requests numerical rating input, and the user input manager 106 processes these concurrent requests according to configured priority levels and timeout parameters. The system might present: “Request 1 (Priority: High): Select deployment region on map interface” followed by “Request 2 (Priority: Normal): Rate the solution quality on a scale of 1-10.” This concurrent processing capability demonstrates the system's ability to manage complex multi-request scenarios while maintaining proper isolation between different agent workflow contexts and ensuring that human users receive appropriately formatted and prioritized interaction requests.

The context-agnostic approach demonstrates a key benefit of the user input manager 106 architecture, where components within any agent workflow can request human feedback without possessing knowledge of their deployment environment or user interface capabilities. In the workflow examples, individual tools within both the first set of tools 212 and second set of tools 214 simply invoke the user input manager 106 with standardized request parameters, and the system automatically handles front-end compatibility validation, request formatting, and response processing. This abstraction enables developers to create reusable agent components that can be deployed across different execution environments, such as from development command line interfaces to production web applications to voice-enabled systems, without necessarily requiring modifications to the core agent logic that determines when and why human input is needed.

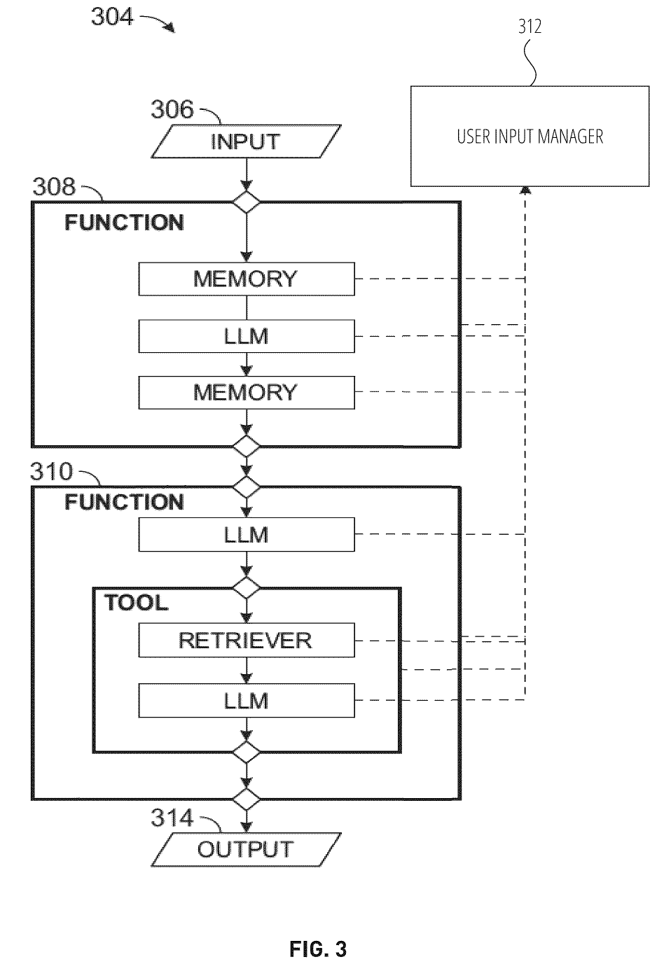

FIG. 3 illustrates a user input manager wrapper system 304, according to at least some embodiments of the present disclosure. Specifically, FIG. 3 illustrates the user input manager wrapper system 304 that demonstrates how the AI agent system 104 enables context-agnostic human feedback collection and universal user input management for AI agent workflows regardless of their underlying framework implementations. This user input manager wrapper system 304 represents the core functionality that enables developers to enhance any workflow with human-in-the-loop capabilities through configuration-driven deployment, showing the flow of data from initial input 306 through user input management coordination to final output 314, while maintaining framework-agnostic abstractions for human feedback collection understanding.

An input 306 represents the starting point where user requests enter the user input manager wrapper system 304 for processing by AI agent workflows enhanced with human feedback collection capabilities. This input 306 may contain various types of user queries that require agent processing with potential human intervention points, similar to how the API server 114 described in FIG. 1 receives requests from developers seeking to enhance their agent workflows with user input management capabilities. The input 306 feeds into the human feedback collection pipeline that enables framework-agnostic user input management across different agent implementations.

A first AI agent workflow 308 (e.g., first function implementation) demonstrates how the user input manager wrapper system 304 can coordinate human feedback collection for agent implementations that include memory components and LLM integration. This first AI agent workflow 308 represents how agents built in frameworks such as LangChain or LlamaIndex can access the user input manager 106 to request human feedback at any point during execution through standardized callback handler mechanisms. The user input management approach allows any component within this workflow to pause execution and request human input without requiring knowledge of the deployment environment or front-end interface configuration.

A second AI agent workflow 310 illustrates an alternative agent architecture that incorporates LLM capabilities, tool integrations with retriever functionality, and additional processing stages that can access the user input manager 106 for human feedback collection. This second AI agent workflow 310 demonstrates the flexibility of the user input management system to handle diverse agent implementations, including those that utilize retrieval-augmented generation patterns through the retriever component, multi-step processing workflows, and complex tool interaction sequences. The user input manager 106 can coordinate human feedback requests from any component within these varied architectures regardless of their complexity or tool composition.

The first AI agent workflow 308 and second AI agent workflow 310 may be built using different underlying frameworks to demonstrate the system's framework-agnostic human feedback collection capabilities. For example, the first AI agent workflow 308 might be implemented using LangChain while the second AI agent workflow 310 could be built using LlamaIndex or CrewAI. The architectural differences between these workflows illustrate the diversity of agent implementations that the user input manager 106 can support for human feedback collection. The second AI agent workflow 310 includes both retriever functionality and multiple LLM processing stages because it may implement complex information gathering patterns where the tool components need to request human confirmation or guidance during retrieval operations. In contrast, the first AI agent workflow 308 focuses on memory-based processing with direct LLM interaction, representing a simpler conversational agent that may require human input for decision validation or clarification requests through its memory components. This diversity in architectural patterns demonstrates how the user input manager wrapper system 304 can provide consistent human feedback collection across different agent implementations regardless of whether they utilize retrieval operations, multiple reasoning steps, or varying combinations of tools and frameworks.

The context-agnostic human feedback collection capabilities enable the user input manager wrapper system 304 to coordinate user input requests from both implementations regardless of their architectural differences or framework origins. The user input manager wrapper system 304 maintains registration data about available front-end interfaces and their callback handlers, then routes human input requests through appropriate communication channels based on the active interface configuration. When any component within either workflow generates requests for human feedback, the user input manager wrapper system 304 (e.g., the user input manager 106) automatically identifies registered callback handlers and transmits formatted requests to front-end interfaces, ensuring seamless integration across different framework implementations while maintaining the separation between agent logic operations and execution context dependencies.

The coordination between the first AI agent workflow 308 and second AI agent workflow 310 through the user input manager wrapper system 304 demonstrates how human feedback collection can be applied uniformly across different workflow components based on standardized request protocols. This interconnection enables the user input manager wrapper system 304 to provide consistent user interaction patterns regardless of which agent framework generates the human input request, allowing developers to deploy agents across multiple frameworks while maintaining unified human feedback collection capabilities. The user input manager wrapper system 304 maintains comprehensive understanding of front-end interface capabilities and user interaction modalities that enables intelligent request routing regardless of whether workflows span multiple frameworks or utilize different implementation approaches.

A user input manager 312 plays a central role in the user input manager wrapper system 304 by coordinating all human feedback collection requests generated by components within the AI agent workflows and routing them to appropriate front-end interfaces. This user input manager 312 implements the callback handler registration system that enables different user interface modalities to register their communication protocols during system initialization, maintaining association data structures that map front-end types to callback function identifiers. The user input manager 312 ensures that any component within either workflow can request human input using standardized request formats, with the system automatically handling front-end compatibility validation, request formatting, and response processing while maintaining the framework-agnostic abstractions that distinguish this system from manual integration approaches.

The data flow from both function implementations toward the user input manager 312 demonstrates how the user input manager wrapper system 304 enables seamless coordination between agent components requiring human feedback and available front-end interfaces capable of collecting user input. The user input manager 312 receives human input requests from any point within the workflow execution hierarchy, identifies appropriate registered callback handlers based on active front-end configuration, and transmits requests through established communication protocols for processing according to specific interaction modalities. This coordination approach ensures that agent workflows can benefit from universal human feedback collection capabilities while maintaining compatibility with existing agent implementations through standardized request routing mechanisms and automatic front-end adaptation capabilities.

An output 314 represents the final stage where processed results from the enhanced agent workflows are delivered to users, demonstrating the successful completion of workflows that may have included multiple human feedback collection cycles during execution. This output 314 stage shows how the user input manager wrapper system 304 enables improved workflow reliability and user control through context-agnostic human feedback collection while maintaining transparency in workflow operation. The user input management approach ensures that agent workflows can leverage the benefits from execution context abstraction and automated request routing, such as consistent user interaction patterns across different deployment environments, without requiring modifications to existing agent implementations.

The configuration-driven callback handler registration shown through the user input manager 312 enables the universal human feedback collection capabilities where AI agent workflows can be enhanced with user input management functionality through simple front-end interface registration during system initialization rather than manual programming. This standardization process ensures that human feedback collection appears consistent regardless of underlying framework implementations, supporting the unified user interaction capabilities that distinguish this system from framework-specific solutions. Developers can connect multiple front-end interfaces such as command line terminals, web-based interfaces, or voice input systems to the same agent workflows, enabling flexible deployment scenarios where human feedback collection can be adapted to different user preferences and execution contexts.

The user input manager wrapper system 304 shown in FIG. 3 provides the context-agnostic human feedback collection and universal user input management capabilities that enable the human-in-the-loop functionality implemented by the AI agent system 104, including automatic front-end interface registration for callback handler provisioning, standardized request routing using registered communication protocols, automatic modality adaptation between request formats and front-end capabilities, and configuration-driven user input management deployment that enables developers to enhance any arbitrary workflow with human feedback collection capabilities through transparent and framework-agnostic integration mechanisms.

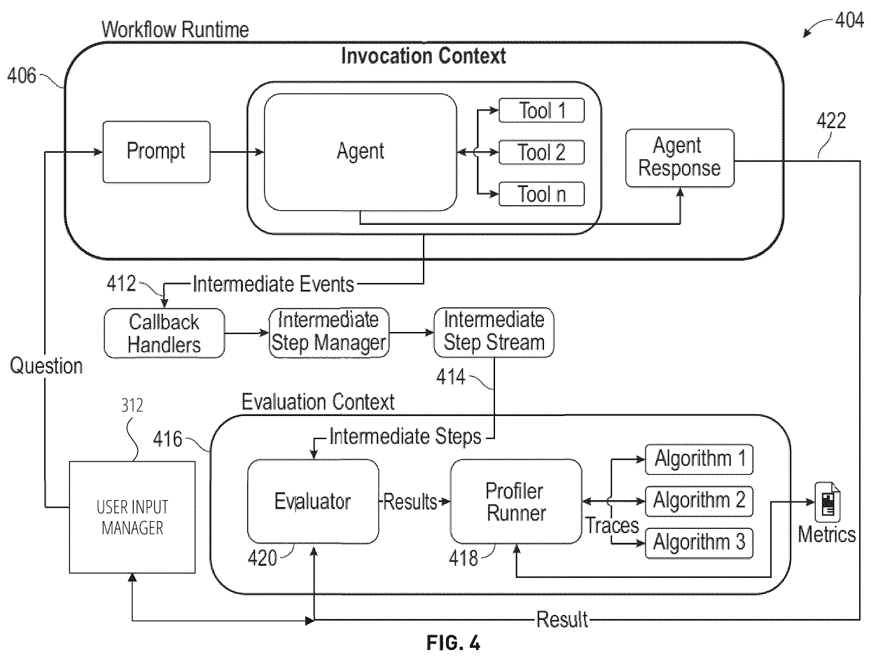

FIG. 4 illustrates a user input manager system 404, according to at least some embodiments of the present disclosure. Specifically, FIG. 4 illustrates the user input manager system 404 that demonstrates the comprehensive human feedback collection coordination and user interface management capabilities of the AI agent system 104 for enhancing AI agent workflows during execution. This user input manager system 404 represents the integration of context-agnostic user input management, callback handler registration, and front-end interface coordination that enables developers to obtain seamless human-in-the-loop functionality from their agent implementations. The user input manager system 404 provides a unified framework for collecting human input requests, coordinating front-end interface communications, and managing concurrent user interaction workflows across AI agent workflows regardless of their underlying framework implementations.

The workflow runtime component serves as the execution environment where AI agent workflows 406 enhanced with human feedback collection capabilities operate and process user requests through registered callback handlers. This runtime environment coordinates the execution of human input collection requests across various workflow components including agents, tools, and other processing elements while maintaining comprehensive user input management instrumentation capabilities. The workflow runtime ensures that all human feedback collection events are properly captured and made available for user interaction analysis and optimization. The invocation context within the workflow runtime component represents the execution environment and state information that surrounds each user input management workflow execution instance, including session data, user information, front-end interface configuration parameters, and callback handler registrations that influence how the AI agent workflow 406 processes human input requests according to registered interface capabilities.

The AI agent workflow 406 represents the target system being enhanced with user input management capabilities, which can include any combination of agents, Tool 1, Tool 2, Tool n, and other components implemented across different frameworks that can access the user input manager for human feedback collection functionality. This workflow executes the core business logic and processing required to handle user queries while maintaining the ability to request human input at any point during execution through standardized callback mechanisms. The AI agent workflow 406 is enhanced through the user input manager system 404 to provide seamless human feedback collection and front-end interface coordination without requiring modifications to the underlying workflow implementation. The prompt component within the workflow represents user queries that initiate agent execution, while the agent response component represents the final output delivered to users after potential human feedback collection cycles.

The intermediate events 412 represent the real-time stream of user input requests, callback handler communications, and front-end interface interactions generated during AI agent workflow execution that require human feedback collection coordination. These intermediate events 412 capture all human-in-the-loop interaction patterns including request formatting, interface compatibility validation, timeout management, and response processing that occur during user input management operations. The intermediate events 412 provide comprehensive visibility into human feedback collection patterns and enable systematic analysis of user interaction effectiveness across different front-end interfaces and agent workflow scenarios.

Callback handlers serve as the communication bridge between the user input manager system and registered front-end interfaces, implementing the registration protocols that enable different user interface modalities to establish communication channels with the user input management infrastructure. These callback handlers maintain the association data structures that map FE types to their corresponding interaction capabilities, enabling the system to validate compatibility between requested input types and available interface functionalities. The callback handlers coordinate with the intermediate step manager to process user input requests through standardized communication protocols regardless of the specific FE interface implementation.

The intermediate step manager coordinates the processing and normalization of user input management data generated during human feedback collection operations, converting framework-specific interaction patterns into standardized representations suitable for analysis and optimization. This component processes the intermediate events 412 through systematic data transformation that maintains temporal ordering and hierarchical relationships between different user input requests and their corresponding front-end interface responses. The intermediate step stream serves as the central data flow mechanism that maintains standardized user input management information in a format suitable for comprehensive analysis and system optimization. This stream processes normalized human feedback collection data through the intermediate steps 414 component, ensuring that all user interaction patterns are captured and made available for evaluation regardless of their originating agent framework or front-end interface modality.

The intermediate steps 414, generated by the intermediate events 412, represent the processed and standardized human feedback collection data and user interface coordination information that has been prepared for analysis and optimization. These intermediate steps 414 include normalized representations of user input requests, callback handler communications, front-end interface interactions, and response processing events generated during human-in-the-loop operations. The intermediate steps 414 maintain temporal ordering and hierarchical relationships that enable comprehensive analysis of user input management effectiveness across different execution contexts and interface modalities.

The user input manager 312 plays the central coordination role in the user input manager system 404 by implementing the core human feedback collection logic that receives requests from AI agent workflows, identifies appropriate registered callback handlers, and coordinates communication with available front-end interfaces. This user input manager 312 implements the callback handler registration system that enables different user interface modalities to establish communication protocols during system initialization, maintaining comprehensive mapping between front-end capabilities and interaction requirements. The user input manager 312 ensures seamless routing of human input requests while implementing graceful error handling when front-end interfaces cannot support requested input types.

Evaluation context 416 contains specific human feedback collection configuration parameters such as front-end interface selection criteria, timeout management policies for different types of user input requests, and compatibility validation thresholds that ensure optimal user interaction experiences. The context also specifies user input management analysis parameters including which validation algorithms to apply for callback handler effectiveness assessment, timeout escalation procedures for unresponsive interfaces, and performance monitoring criteria for concurrent request handling across multiple front-end interfaces simultaneously.

The evaluation context 416 also includes workflow-specific user input management configuration parameters that customize the human feedback collection approach based on the type of agent workflow and expected user interaction patterns. For instance, the evaluation context 416 may specify that real-time decision-making workflows should prioritize low-latency interface connections with immediate callback responses, while analytical workflows may emphasize comprehensive input collection with extended timeout periods and detailed validation procedures. The context defines custom interface selection configurations appropriate for different workflow types, establishes baseline human interaction quality metrics derived from previous user input management deployments, and configures the scope and frequency of user interaction monitoring processes.

An evaluator component 420 implements the user input management validation logic that assesses human feedback collection effectiveness, front-end interface performance, and callback handler reliability across different execution scenarios. This evaluator component 420 applies various analysis metrics and algorithms to the collected user interaction data to generate quantitative assessments of user input management deployment success and identify optimization opportunities. The evaluator component 420 supports multiple validation methodologies and can be configured to assess different aspects of human feedback collection performance including response time analysis, interface compatibility rates, and user satisfaction measurements across different front-end modalities.

The evaluator component 420 implements user input management validation logic that operates on the standardized intermediate steps 414 and evaluation context 416 to generate comprehensive assessments of human feedback collection quality and front-end interface effectiveness across multiple dimensions. This evaluator component 420 applies diverse validation methodologies including callback handler response time metrics that analyze communication efficiency and interface compatibility assessments, as well as user interaction pattern analysis that evaluates the effectiveness of different front-end modalities for various types of input requests. The system runs Algorithm 1, Algorithm 2, and Algorithm 3 to perform comprehensive analysis of user input management performance characteristics.

A profiler component 418 implements specialized user input management analysis algorithms that focus on human feedback collection patterns, FE interface utilization characteristics, and callback handler performance optimization. This profiler component 418 analyzes user interaction execution traces to identify efficiency improvements in human feedback collection processes, interface selection bottlenecks, and timeout management optimization opportunities. The profiler component 418 generates detailed user input management performance reports including interaction quality metrics, response time analysis, and interface effectiveness measurements that help developers understand and optimize their human-in-the-loop implementations across different agent architectures. The profiler component 418 produces traces and metrics that feed into the comprehensive analysis framework.

A results 422 component consolidates and presents the outcomes of the user input management evaluation and human feedback collection analysis in formats suitable for developer consumption. These results 422 include user input management deployment reports, FE interface performance insights, callback handler optimization recommendations, and comparative analysis across different interface configurations or agent workflow implementations. The results 422 are formatted to support both automated user input management optimization and human interpretation of human feedback collection effectiveness patterns.

The user input manager system 404 coordinates the interaction between all these components to provide a comprehensive human feedback collection analysis framework that operates transparently during user input request processing and front-end interface coordination. The system automatically discovers available user interface front-ends during initialization, registers appropriate callback handler instrumentation, collects and normalizes user interaction data, applies validation algorithms, and generates actionable insights that help developers understand and optimize their human-in-the-loop deployments across different framework implementations and agent workflow deployment scenarios.

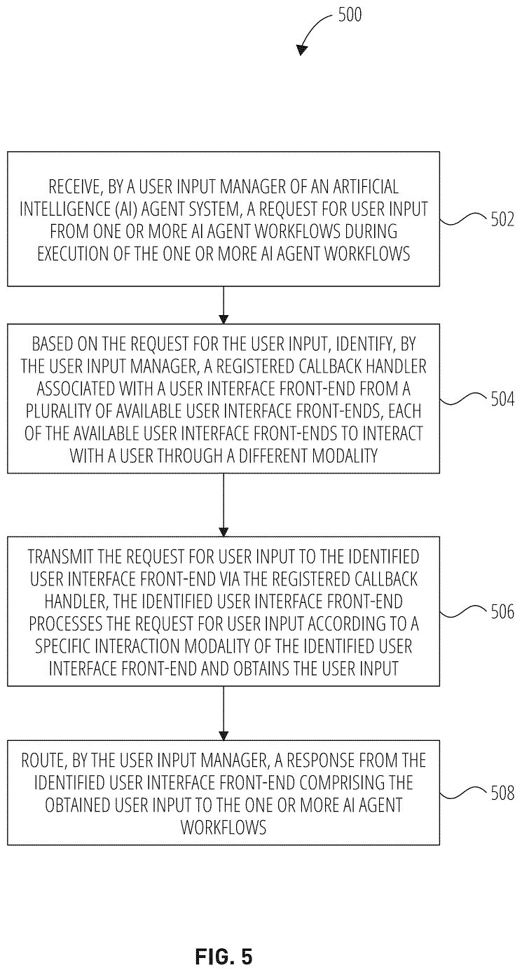

Now referring to FIG. 5, each block (or operation) of method 500, described herein, comprises a computing process that may be performed using any combination of hardware, firmware, and/or software. For instance, various functions may be carried out using one or more processors executing instructions stored in one or more memories. The method 500 may also be embodied as computer-usable instructions stored on computer storage media. The method 500 may be provided by a standalone application, a service or hosted service (standalone or in combination with another hosted service), as a microservice via an application programming interface (API), or a plug-in to another product, to name a few. In addition, the method 500 is described, by way of example, with respect to the AI agent system 104 of FIG. 1. However, this method 500 may additionally or alternatively be executed by any one system, or any combination of systems, including, but not limited to, those described herein. Specifically, the method 500 can be performed by any component shown in FIG. 1.

At operation 502, the AI agent system 104 receives, by a user input manager of an AI agent system, a request for user input from one or more AI agent workflows during execution of the one or more AI agent workflows. This operation represents the initial step where any component within executing AI agent workflows can generate requests for human feedback through the user input manager, regardless of the workflow's framework implementation or execution depth within the agent hierarchy.

At operation 504, based on the request for the user input, the AI agent system 104 identifies, by the user input manager 106, a registered callback handler associated with a user interface front-end from a plurality of available user interface front-ends. Each of the available user interface front-ends interacts with a user through a different modality. During this operation, the user input manager 106 analyzes the request characteristics and consults the configuration component 110 to determine which registered front-end interface is currently active and capable of handling the specific type of input request, whether it be confirmation, text input, geographic selection, or other interaction types.

At operation 506, the AI agent system 104 transmits the request for user input to the identified user interface front-end via the registered callback handler and the identified user interface front-end processes the request for user input according to a specific interaction modality of the identified user interface front-end and obtains the user input. This operation involves the user input manager 106 formatting the request appropriately for the target interface modality and invoking the registered callback function to initiate user interaction through the specific front-end, whether it be command line prompts, web-based interface elements, voice input systems, or other interface types.

At operation 508, the AI agent system 104 routes, by the user input manager 106, a response from the identified user interface front-end comprising the obtained user input to the one or more AI agent workflows. In this final operation, the user input manager receives the processed user response from the front-end interface, performs any necessary format conversions to match the requirements of the requesting agent component, and delivers the formatted response back to the original workflow component that initiated the human input request, enabling the agent workflow to continue execution with the collected human feedback.

The systems and methods described herein may be used for a variety of purposes, by way of example and without limitation, for machine (e.g., robot, vehicle, construction machinery, warehouse vehicles/machines, autonomous, semi-autonomous, and/or other machine types) control, machine locomotion, machine driving, synthetic data generation, model training (e.g., using real, augmented, and/or synthetic data, such as synthetic data generated using a simulation platform or system, synthetic data generation techniques such as but not limited to those described herein, etc.), perception, augmented reality (AR), virtual reality (VR), mixed reality (MR), robotics, security and surveillance (e.g., in a smart cities implementation), autonomous or semi-autonomous machine applications, deep learning, environment simulation, object or actor simulation and/or digital twinning, data center processing, conversational AI, light transport simulation (e.g., ray-tracing, path tracing, etc.), distributed or collaborative content creation for 3D assets (e.g., using universal scene descriptor (USD) data, such as OpenUSD, and/or other data types), cloud computing, generative artificial intelligence (e.g., using one or more diffusion models, transformer models, etc.), and/or any other suitable applications.

Disclosed embodiments may be comprised in a variety of different systems such as automotive systems (e.g., a control system for an autonomous or semi-autonomous machine, a perception system for an autonomous or semi-autonomous machine), systems implemented using a robot or robotic platform, aerial systems, medial systems, boating systems, smart area monitoring systems, systems for performing deep learning operations, systems for performing simulation operations (e.g., in a driving or vehicle simulation, in a robotics simulation, in a smart cities or surveillance simulation, etc.), systems for performing digital twin operations (e.g., in conjunction with a collaborative content creation platform or system, such as, without limitation, NVIDIA's OMNIVERSE and/or another platform, system, or service that uses USD or OpenUSD data types), systems implemented using an edge device, systems using or deploying one or more inference microservices, systems incorporating one or more machine learning models deployed in a service or microservice along with an OS-level virtualization package; systems incorporating one or more virtual machines (VMs), systems for performing synthetic data generation operations (e.g., using one or more neural rendering fields (NERFs), Gaussian splat techniques, diffusion models, transformer models, etc.), systems implemented at least partially in a data center, systems for performing conversational AI operations, systems implementing one or more language models-such as one or more large language models (LLMs), one or more small language models (SLMs), one or more vision language models (VLMs), one or more multi-modal language models, etc., systems for performing light transport simulation, systems for performing collaborative content creation for 3D assets (e.g., using universal scene descriptor (USD) data, such as OpenUSD, computer aided design (CAD) data, 2D and/or 3D graphics or design data, and/or other data types), systems implemented at least partially using cloud computing resources, and/or other types of systems.

### Example Language Models

In at least some embodiments, language models (e.g., the AI agent workflows 116), such as large language models (LLMs), small language models (SLMs), vision language models (VLMs), multi-modal language models (MMLMs), and/or other types of generative artificial intelligence (AI) may be implemented. These models may be capable of understanding, summarizing, translating, and/or otherwise generating text (e.g., natural language text, code, etc.), images, video, computer aided design (CAD) assets, OMNIVERSE and/or METAVERSE file information (e.g., in USD format, such as OpenUSD), and/or the like, based on the context provided in input prompts or queries. These language models may be considered “large,” in embodiments, based on the models being trained on massive datasets and having architectures with a large number of learnable network parameters (weights and biases)—such as millions or billions of parameters. The LLMs/SLMs/VLMs/MMLMs/etc. may be implemented for summarizing textual data, analyzing and extracting insights from data (e.g., textual, image, video, etc.), and generating new text/image/video/etc. in user-specified styles, tones, and/or formats. The LLMs/SLMs/VLMs/MMLMs/etc. of the present disclosure may be used exclusively for text processing, in embodiments, whereas in other embodiments, multi-modal LLMs may be implemented to accept, understand, and/or generate text and/or other types of content like images, audio, 2D and/or 3D data (e.g., in USD formats), and/or video. For example, vision language models (VLMs), or more generally multi-modal language models (MMLMs), may be implemented to accept image, video, audio, textual, 3D design (e.g., CAD), and/or other inputs data types and/or to generate or output image, video, audio, textual, 3D design, and/or other output data types.

Various types of LLMs/SLMs/VLMs/MMLMs/etc. architectures may be implemented in various embodiments. For example, different architectures may be implemented that use different techniques for understanding and generating outputs, such as text, audio, video, image, 2D and/or 3D design or asset data, etc. In some embodiments, LLMs/SLMs/VLMs/MMLMs/etc. architectures such as recurrent neural networks (RNNs) or long short-term memory networks (LSTMs) may be used, while in other embodiments transformer architectures, such as those that rely on self-attention and/or cross-attention (e.g., between contextual data and textual data) mechanisms, may be used to understand and recognize relationships between words or tokens and/or contextual data (e.g., other text, video, image, design data, USD, etc.). One or more generative processing pipelines that include LLMs/SLMs/VLMs/MMLMs/etc. may also include one or more diffusion block(s) (e.g., denoisers). The LLMs/SLMs/VLMs/MMLMs/etc. of the present disclosure may include encoder and/or decoder block(s). For example, discriminative or encoder-only models like BERT (Bidirectional Encoder Representations from Transformers) may be implemented for tasks that involve language comprehension such as classification, sentiment analysis, question answering, and named entity recognition. As another example, generative or decoder-only models like GPT (Generative Pretrained Transformer) may be implemented for tasks that involve language and content generation such as text completion, story generation, and dialogue generation. LLMs/SLMs/VLMs/MMLMs/etc. that include both encoder and decoder components like T5 (Text-to-Text Transformer) may be implemented to understand and generate content, such as for translation and summarization. These examples are not intended to be limiting, and any architecture type (including, but not limited to those described herein) may be implemented depending on the particular embodiment and the task(s) being performed using the LLMs/SLMs/VLMs/MMLMs/etc.

In various embodiments, the LLMs/SLMs/VLMs/MMLMs/etc. may be trained using unsupervised learning, in which an LLMs/SLMs/VLMs/MMLMs/etc. learns patterns from large amounts of unlabeled text/audio/video/image/design/USD/etc. data. Due to the extensive training of embodiments, the models may not need task-specific or domain-specific training. LLMs/SLMs/VLMs/MMLMs/etc. that have undergone extensive pre-training on vast amounts of unlabeled data may be referred to as foundation models and may be adept at a variety of tasks like question-answering, summarization, filling in missing information, translation, image/video/design/USD/data generation. Some LLMs/SLMs/VLMs/MMLMs/etc. may be tailored for a specific use case using techniques like prompt tuning, fine-tuning, retrieval augmented generation (RAG), adding adapters (e.g., customized neural networks, and/or neural network layers, that tune or adjust prompts or tokens to bias the language model toward a particular task or domain), and/or using other fine-tuning or tailoring techniques that optimize the models for use on particular tasks and/or within particular domains.

In some embodiments, the LLMs/SLMs/VLMs/MMLMs/etc. of the present disclosure may be implemented using various model-alignment techniques. For example, in some embodiments, guardrails may be implemented to identify improper or undesired inputs (e.g., prompts) and/or outputs of the models. In doing so, the system may use the guardrails and/or other model-alignment techniques to either prevent a particular undesired input from being processed using the LLMs/SLMs/VLMs/MMLMs/etc., and/or preventing the output or presentation (e.g., display, audio output, etc.) of information generated using the LLMs/SLMs/VLMs/MMLMs/etc. In some embodiments, one or more additional models (or layers thereof) may be implemented to identify issues with inputs and/or outputs of the models. For example, these “safeguard” models may be trained to identify inputs and/or outputs that are “safe” or otherwise okay or desired and/or that are “unsafe” or are otherwise undesired for the particular application/implementation. As a result, the LLMs/SLMs/VLMs/MMLMs/etc. of the present disclosure may be less likely to output language/text/audio/video/design data/USD data/etc. that may be offensive, vulgar, improper, unsafe, out of domain, and/or otherwise undesired for the particular application/implementation.

In some embodiments, the LLMs/SLMs/VLMs/MSLMs/MLMs/MMLMs/etc. may be configured to access or to be capable of accessing or using one or more plug-ins, application programming interfaces (APIs), databases, data stores, repositories, etc. For example, for certain tasks or operations that the model is not ideally suited for, the model may have instructions (e.g., as a result of training, and/or based on instructions in a given prompt) to access one or more plug-ins (e.g., third-party plugins) for help in processing the current input. In such an example, where at least part of a prompt is related to restaurants or weather, the model may access one or more restaurant or weather plug-ins (e.g., via one or more APIs) to retrieve the relevant information. As another example, where at least part of a response requires or benefits from a mathematical computation, the model may access one or more math plug-ins or APIs for help in solving the problem(s), and may then use the response from the plug-in and/or API in the output from the model. This process may be repeated (e.g., recursively) for any number of iterations and using any number of plug-ins and/or APIs until a response to the input prompt can be generated that addresses each ask/question/request/process/operation/etc. As such, the model(s) may not only rely on its own knowledge from training on a large dataset(s), but also on the expertise or optimized nature of one or more external resources, such as APIs, plug-ins, and/or the like.

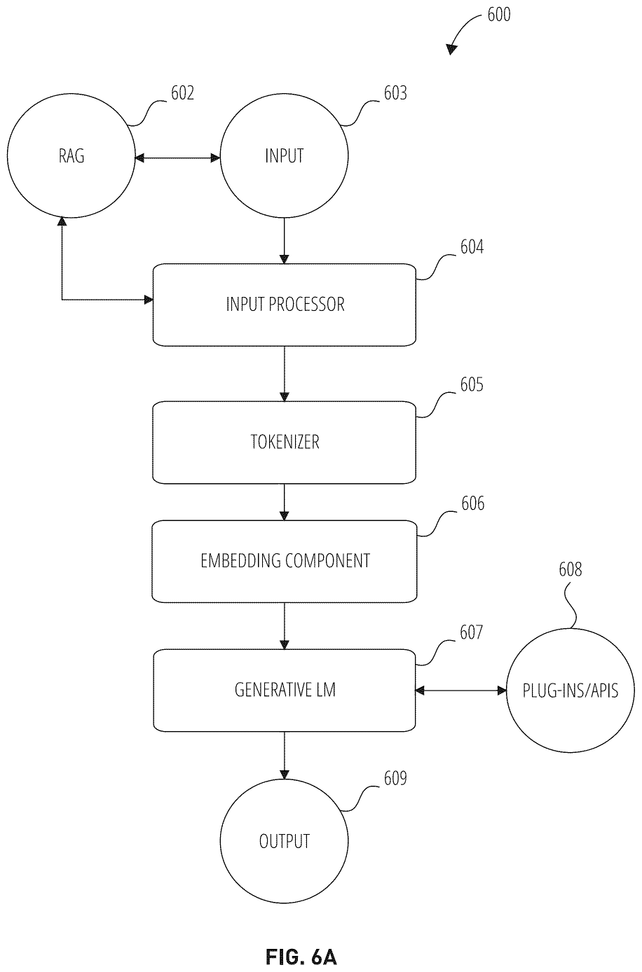

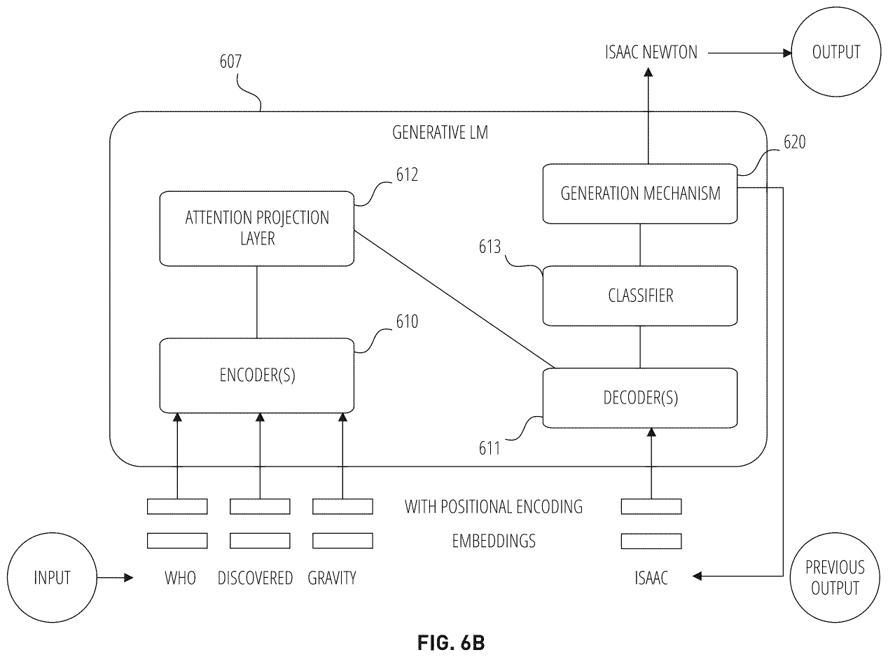

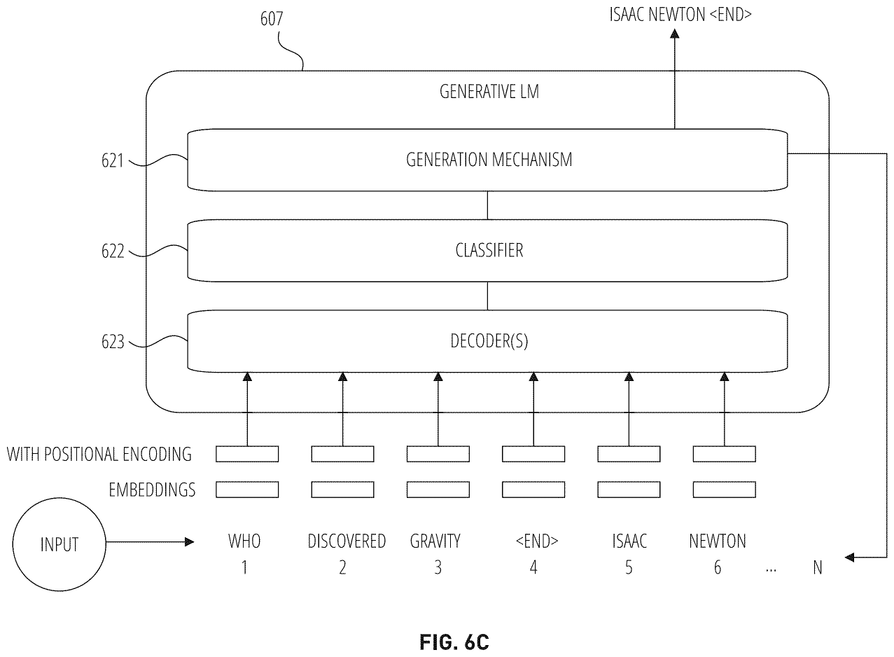

For example, and with reference to FIG. 6A, the generative LM 607 can access external resources through plug-ins/APIs 608 to enhance its capabilities beyond its internal knowledge base. When processing inputs, the generative LM 607 can intelligently determine when to utilize specific plug-ins/APIs 608 based on the requirements of the task. For example, when generating code, the generative LM 607 may access code execution environments through plug-ins/APIs 608 to test and validate solutions before providing them as output 609. The system enables coordinated use of multiple plug-ins/APIs 608 during generation, where the generative LM 607 can sequence different verification tools based on the specific requirements of the task. For instance, when solving mathematical problems, the generative LM 607 may first use symbolic computation plug-ins to verify equations, then access mathematical proof validation tools to check logical consistency, and finally employ formatting plug-ins to ensure proper mathematical notation in the output 609. This layered verification approach allows the generative LM 607 to produce outputs that are not only technically correct but also properly formatted and documented.

The plug-ins/APIs 608 integration is particularly valuable for verification tasks, as it allows the generative LM 607 to dynamically validate its outputs using domain-specific tools. For example, when generating code, the generative LM 607 can use syntax checkers, linters, and runtime environments accessed through plug-ins/APIs 608 to verify correctness, style, and execution behavior. The system can recursively apply these verification tools, using the feedback to refine the output 609 until it meets the required quality standards.

In some embodiments, multiple language models (e.g., LLMs/SLMs/VLMs/MMLMs/etc.) multiple instances of the same language model, and/or multiple prompts provided to the same language model or instance of the same language model may be implemented, executed, or accessed (e.g., using one or more plug-ins, user interfaces, APIs, databases, data stores, repositories, etc.) to provide output responsive to the same query, or responsive to separate portions of a query. In at least one embodiment, multiple language models, e.g., language models with different architectures and language models trained on different (e.g., updated) corpora of data, may be provided with the same input query and prompt (e.g., set of constraints, conditioners, etc.). In one or more embodiments, the language models may be different versions of the same foundation model. In one or more embodiments, at least one language model may be instantiated as multiple agents (e.g., more than one prompt may be provided to constrain, direct, or otherwise influence a style, a content, or a character, etc.,) of the output provided. In one or more example non-limiting embodiments, the same language model may be asked to provide output corresponding to a different role, perspective, character, or having a different base of knowledge, etc., as defined by a supplied prompt.

In any one of such embodiments, the output of two or more (e.g., each) language models, two or more versions of at least one language model, two or more instanced agents of at least one language model, and/or two or more prompts provided to at least one language model may be further processed (e.g., aggregated, compared or filtered against), or used to determine (and provide) a consensus response. In one or more embodiments, the output from one language model—or version, instance, or agent—may be provided as input to another language model for further processing and/or validation. In one or more embodiments, a language model may be asked to generate or otherwise obtain an output with respect to an input source material, with the output being associated with the input source material. Such an association may include, for example, the generation of a caption or portion of text that is embedded (e.g., as metadata) with an input source text or image. In one or more embodiments, an output of a language model may be used to determine the validity of an input source material for further processing or inclusion in a dataset. For example, a language model may be used to assess the presence (or absence) of a target word in a portion of text or an object in an image, with the text or image being annotated to note such presence (or lack thereof). Alternatively, the determination from the language model may be used to determine whether the source material should be included in a curated dataset, for example and without limitation.

FIG. 6A is a block diagram of an example generative LLM system, generative LLM system 600, suitable for use in implementing at least some embodiments of the present disclosure. In the example illustrated in FIG. 6A, the generative LLM system 600 includes a retrieval augmented generation (RAG) component 602, an input processor 604, a tokenizer 605, an embedding component 606, a generative LM 607 (which may include an LLM, a SLM, a VLM, a multi-modal LM, etc.), and plug-ins/APIs 608.

At a high level, the input processor 604 may receive an input 603 comprising text and/or other types of input data (e.g., audio data, video data, image data, sensor data [e.g., LiDAR, RADAR, ultrasonic, etc.]), 3D design data, CAD data, universal scene descriptor (USD) data (e.g., OpenUSD), depending on the architecture of the generative LM 607 (e.g., LLM/SLM/VLM/MMLM/etc.). In some embodiments, the input 603 includes plain text in the form of one or more sentences, paragraphs, and/or documents. Additionally, or alternatively, the input 603 may include numerical sequences, precomputed embeddings (e.g., word or sentence embeddings), and/or structured data (e.g., in tabular formats, JSON, or XML). In some implementations in which the generative LM 607 is capable of processing multi-modal inputs, the input 603 may combine text (or may omit text) with image data, audio data, video data, design data, USD data, and/or other types of input data, such as but not limited to those described herein. Taking raw input text as an example, the input processor 604 may prepare raw input text in various ways. For example, the input processor 604 may perform various types of text filtering to remove noise (e.g., special characters, punctuation, HTML tags, stopwords, portions of an image(s), portions of audio, etc.) from relevant textual content. In an example involving stopwords (common words that tend to carry little semantic meaning), the input processor 604 may remove stopwords to reduce noise and focus the generative LM 607 on more meaningful content. The input processor 604 may apply text normalization, for example, by converting all characters to lowercase, removing accents, and/or handling special cases like contractions or abbreviations to ensure consistency. These are just a few examples, and other types of input processing may be applied.

In some embodiments, a RAG component 602 (which may include one or more RAG models, and/or may be performed using the generative LM 607 itself) may be used to retrieve additional information to be used as part of the input 603 or prompt. The RAG component 602 may be used to enhance the input to the LLM/SLM/VLM/MMLM/etc. with external knowledge, so that answers to specific questions or queries or requests are more relevant-such as in a case where specific knowledge is involved. The RAG component 602 may fetch this additional information (e.g., grounding information, such as grounding text/image/video/audio/USD/CAD/etc.) from one or more external sources, which can then be fed to the LLM/SLM/VLM/MMLM/etc. along with the prompt to improve the accuracy of the responses or outputs of the model.

For example, in some embodiments, the input 603 may be generated using the query or input to the model (e.g., a question, a request, etc.) in addition to data retrieved using the RAG component 602. In some embodiments, the input processor 604 may analyze the input 603 and communicate with the RAG component 602 (or the RAG component 602 may be part of the input processor 604, in embodiments) in order to identify relevant text and/or other data to provide to the generative LM 607 as additional context or sources of information from which to identify the response, answer, or output 609, generally. For example, where the input 603 indicates that the user is interested in a desired tire pressure for a particular make and model of vehicle, the RAG component 602 may retrieve, using a RAG model performing a vector search in an embedding space, for the tire pressure information or the text corresponding thereto from a digital (embedded) version of the user manual for that particular vehicle make and model. Similarly, where a user revisits a chatbot related to a particular product offering or service, the RAG component 602 may retrieve a prior stored conversation history, or at least a summary thereof, and include the prior conversation history along with the current ask/request as part of the input 603 to the generative LM 607.

For example, in some embodiments, the input 603 may be generated using the query or input to the model (e.g., a question, a request, etc.) in addition to data retrieved using the RAG component 602. This integration creates a comprehensive input package that combines the original task requirements with contextually relevant information for evaluation. The input 603 can take various forms, such as a structured data object containing multiple elements: the original query or task description, verification criteria for the AI agent workflows 116, and relevant reference information retrieved by the RAG component 602. When processing a task like “Implement a binary search tree insertion algorithm,” the input 603 can include not only this request but also relevant documentation, test cases, and performance metrics that the AI agent workflows 116 will use to assess the generated solution.

The input processor 604 analyzes this enriched input package and communicates with the RAG component 602 to identify additional verification resources needed for comprehensive evaluation. The input processor 604 may analyze task characteristics to determine which verification approaches are most or most likely appropriate and prepares the contextual information needed for thorough evaluation.

The RAG component 602 might also retrieve historical evaluation data from previous optimization cycles. For instance, if a particular type of prompt has consistently led to higher-quality outputs in similar domains, the RAG component 602 can retrieve this historical context to inform the current optimization strategy. This ensures continuous improvement across evaluation sessions while applying lessons learned from previous optimization attempts. The AI agent system 104 orchestrates this process by determining which historical optimization data is relevant to the current task and how it should influence parameter adjustments, creating a self-improving system that progressively enhances output quality through intelligent evaluation and targeted refinement.

The RAG component 602 may use various RAG techniques. For example, naïve RAG may be used where documents are indexed, chunked, and applied to an embedding model to generate embeddings corresponding to the chunks. A user query may also be applied to the embedding model and/or another embedding model of the RAG component 602 and the embeddings of the chunks along with the embeddings of the query may be compared to identify the most similar/related embeddings to the query, which may be supplied to the generative LM 607 to generate an output.

In some embodiments, more advanced RAG techniques may be used. For example, prior to passing chunks to the embedding model, the chunks may undergo pre-retrieval processes (e.g., routing, rewriting, metadata analysis, expansion, etc.). In addition, prior to generating the final embeddings, post-retrieval processes (e.g., re-ranking, prompt compression, etc.) may be performed on the outputs of the embedding model prior to final embeddings being used as comparison to an input query.

As a further example, modular RAG techniques may be used, such as those that are similar to naïve and/or advanced RAG, but also include features such as hybrid search, recursive retrieval and query engines, StepBack approaches, sub-queries, and hypothetical document embedding.

As another example, graph RAG may use knowledge graphs as a source of context or factual information. Graph RAG may be implemented using a graph database as a source of contextual information sent to the LLM/SLM/VLM/MMLM/etc. Rather than (or in addition to) providing the model with chunks of data extracted from larger sized documents, which may result in a lack of context, factual correctness, language accuracy, etc., graph RAG may also provide structured entity information to the LLM/SLM/VLM/MMLM/etc. by combining the structured entity textual description with its many properties and relationships, allowing for deeper insights by the model. When implementing graph RAG, the systems and methods described herein use a graph as a content store and extract relevant chunks of documents and ask the LLM/SLM/VLM/MMLM/etc. to answer using them. The knowledge graph, in such embodiments, may contain relevant textual content and metadata about the knowledge graph as well as be integrated with a vector database. In some embodiments, the graph RAG may use a graph as a subject matter expert, where descriptions of concepts and entities relevant to a query/prompt may be extracted and passed to the model as semantic context. These descriptions may include relationships between the concepts. In other examples, the graph may be used as a database, where part of a query/prompt may be mapped to a graph query, the graph query may be executed, and the LLM/SLM/VLM/MMLM/etc. may summarize the results. In such an example, the graph may store relevant factual information, and a query (natural language query)-to-graph query tool (NL-to-graph query tool) and entity linking may be used. In some embodiments, graph RAG (e.g., using a graph database) may be combined with standard (e.g., vector database) RAG, and/or other RAG types, to benefit from multiple approaches.

In any embodiments, the RAG component 602 may implement a plugin, API, user interface, and/or other functionality to perform RAG. For example, a graph RAG plug-in may be used by the LLM/SLM/VLM/MMLM/etc. to run queries against the knowledge graph to extract relevant information for feeding to the model, and a standard or vector RAG plug-in may be used to run queries against a vector database. For example, the graph database may interact with a plug-in's REST interface such that the graph database is decoupled from the vector database and/or the embeddings models.

The tokenizer 605 may segment the (e.g., processed) text data into smaller units (tokens) for subsequent analysis and processing. The tokens may represent individual words, subwords, characters, portions of audio/video/image/etc., depending on the implementation. Word-based tokenization divides the text into individual words, treating each word as a separate token. Subword tokenization breaks down words into smaller meaningful units (e.g., prefixes, suffixes, stems), enabling the generative LM 607 to understand morphological variations and handle out-of-vocabulary words more effectively. Character-based tokenization represents each character as a separate token, enabling the generative LM 607 to process text at a fine-grained level. The choice of tokenization strategy may depend on factors such as the language being processed, the task at hand, and/or characteristics of the training dataset. As such, the tokenizer 605 may convert the (e.g., processed) text into a structured format according to tokenization schema being implemented in the particular embodiment.

The embedding component 606 may use any known embedding technique to transform discrete tokens into (e.g., dense, continuous vector) representations of semantic meaning. For example, the embedding component 606 may use pre-trained word embeddings (e.g., Word2Vec, GloVe, or FastText), one-hot encoding, Term Frequency-Inverse Document Frequency (TF-IDF) encoding, one or more embedding layers of a neural network, and/or otherwise).

In some implementations in which the input 603 includes image data/video data/etc., the input processor 604 may resize the data to a standard size compatible with the format of a corresponding input channel and/or may normalize pixel values to a common range (e.g., 0 to 1) to ensure a consistent representation, and the embedding component 606 may encode the image data using any known technique (e.g., using one or more convolutional neural networks (CNNs) to extract visual features). In some implementations in which the input 603 includes audio data, the input processor 604 may resample an audio file to a consistent sampling rate for uniform processing, and the embedding component 606 may use any known technique to extract and encode audio features-such as in the form of a spectrogram (e.g., a mel-spectrogram). In some implementations in which the input 603 includes video data, the input processor 604 may extract frames or apply resizing to extracted frames, and the embedding component 606 may extract features such as optical flow embeddings or video embeddings and/or may encode temporal information or sequences of frames. In some implementations in which the input 603 includes multi-modal data, the embedding component 606 may fuse representations of the different types of data (e.g., text, image, audio, USD, video, design, etc.) using techniques like early fusion (concatenation), late fusion (sequential processing), attention-based fusion (e.g., self-attention, cross-attention), etc.

The generative LM 607 and/or other components of the generative LLM system 600 may use different types of neural network architectures depending on the implementation. For example, transformer-based architectures such as those used in models like GPT may be implemented, and may include self-attention mechanisms that weigh the importance of different words or tokens in the input sequence and/or feedforward networks that process the output of the self-attention layers, applying nonlinear transformations to the input representations and extracting higher-level features. Some non-limiting example architectures include transformers (e.g., encoder-decoder, decoder only, multi-modal), RNNs, LSTMs, fusion models, diffusion models, cross-modal embedding models that learn joint embedding spaces, graph neural networks (GNNs), hybrid architectures combining different types of architectures adversarial networks like generative adversarial networks or GANs or adversarial autoencoders (AAEs) for joint distribution learning, and others. As such, depending on the implementation and architecture, the embedding component 606 may apply an encoded representation of the input 603 to the generative LM 607, and the generative LM 607 may process the encoded representation of the input 603 to generate an output 609, which may include responsive text and/or other types of data.

As described herein, in some embodiments, the generative LM 607 may be configured to access or use- or be capable of accessing or using-plug-ins/APIs 608 (which may include one or more plug-ins, application programming interfaces (APIs), databases, data stores, repositories, etc.). For example, for certain tasks or operations that the generative LM 607 is not ideally suited for, the model may have instructions (e.g., as a result of training, and/or based on instructions in a given prompt, such as those retrieved using the RAG component 602) to access one or more plug-ins/APIs 608 (e.g., third-party plugins) for help in processing the current input. In such an example, where at least part of a prompt is related to restaurants or weather, the model may access one or more restaurant or weather plug-ins (e.g., via one or more APIs), send at least a portion of the prompt related to the particular plug-ins/APIs 608 to the plug-ins/APIs 608, the plug-ins/APIs 608 may process the information and return an answer to the generative LM 607, and the generative LM 607 may use the response to generate the output 609. This process may be repeated (e.g., recursively) for any number of iterations and using any number of plug-ins/APIs 608 until an output 609 that addresses each ask/question/request/process/operation/etc. from the input 603 can be generated. As such, the model(s) may not only rely on its own knowledge from training on a large dataset(s) and/or from data retrieved using the RAG component 602, but also on the expertise or optimized nature of one or more external resources, such as the plug-ins/APIs 608.

The generative LM 607 can access external resources through plug-ins/APIs 608 to enhance its capabilities beyond its internal knowledge base. This integration is particularly valuable in evaluation and optimization workflows performed by the AI agent system 104, where the generative LM 607 may need to verify outputs or access specialized domain knowledge. When processing complex coding tasks, for instance, the generative LM 607 can identify syntax patterns in user input and automatically initiate API calls to code verification tools like interpreters or linters, incorporating proper programming standards while preserving the original output structure. The system may recursively query multiple specialized verification resources-progressing from code execution to syntax validation and finally to style analysis-before generating comprehensive evaluation data that maintains output quality while incorporating expert verification signals.

In optimization implementations, the system orchestrates complementary verification through targeted API integrations, allowing the generative LM 607 to access code interpreters for functional validation while simultaneously querying style checkers and mathematical validators when appropriate. This coordinated multi-source integration creates comprehensive evaluation perspectives impossible with single-source information models, while maintaining consistent output quality assessment. Similarly, in mathematical verification contexts, the generative LM 607 can reference symbolic problem solvers through API connections, execute computational verifications through code interpreters, and verify logical consistency through mathematical validation tools-all while maintaining its evaluation objectives and optimization goals within a coherent evaluation-optimization cycle.

Furthermore, the plugin integration architecture supports conditional access patterns where verification tools are dynamically selected based on the output domain. The input processor 604 can be configured through the API call structure to implement rules such as “use code interpreters when programming outputs are detected” or “reference mathematical validators when processing proofs.” The generative LM 607 processes these different plugin response streams within the context of the evaluation objectives, enabling sophisticated verification processes where multiple tools can build upon each other's verification signals while maintaining consistent evaluation standards. This approach significantly enhances the evaluation accuracy beyond what either standard comparison or single-tool verification can achieve, as the system maintains both comprehensive verification capabilities and access to specialized knowledge resources appropriate to each output domain.

In some embodiments, user input manager 106 and FE interface coordination may be implemented as components within AI agent workflows 116 that operate across multiple agent frameworks, requiring comprehensive callback handler registration and human feedback collection capabilities that extend beyond traditional manual integration approaches. The AI agent system 104 described herein enables framework-agnostic user input management functionality and dynamic FE interface discovery of these language model implementations regardless of whether they are deployed within LangChain, LlamaIndex, CrewAI, Semantic Kernel, or other agent framework environments. This approach allows developers to obtain unified human-in-the-loop capabilities across heterogeneous agent architectures where different generative LMs may be integrated with various tools, retrievers, and memory components, creating complex multi-framework workflows that require standardized user input management deployment methodologies.

The language models operating within these AI agent workflows 116 may be subject to comprehensive user input management integration through automated callback handler registration that captures front-end interface capabilities, interaction modalities, and communication protocols during system initialization. The system may register dynamic front-end interface discovery capabilities that analyze available user interface implementations including command line terminals, web-based interfaces, and voice input systems, extracting relevant metadata such as interface types, supported input types, timeout parameters, and callback function identifiers from each registered front-end component. This metadata extraction occurs transparently without requiring modifications to the underlying language model implementations, enabling developers to deploy user input management functionality including request routing, automatic modality adaptation, graceful error handling, and response processing across different stages of agent workflow execution.

Furthermore, the user input management deployment capabilities may include configuration-driven integration where language models are enhanced with human feedback collection capabilities through simple front-end interface registration during system startup rather than manual programming requirements. The system may generate standardized user input requests that capture comprehensive workflow understanding, enabling separation of agent logic operations from execution context dependencies performed by the underlying generative LMs across concurrent agent workflow implementations. These comprehensive user input management insights enable optimization of language model deployment strategies, human interaction approaches, and resource allocation decisions while maintaining compatibility with existing agent implementations through standardized callback mechanisms that support automatic request formatting and cross-framework integration capabilities.

FIG. 6B is a block diagram of an example implementation in which the generative LM 607 includes a transformer encoder-decoder. For example, assume input text such as “Who discovered gravity” is tokenized (e.g., by the tokenizer 605 of FIG. 6A) into tokens such as words, and each token is encoded (e.g., by the embedding component 606 of FIG. 6A) into a corresponding embedding. Since these token embeddings typically do not represent the position of the token in the input sequence, any known technique may be used to add a positional encoding to each token embedding to encode the sequential relationships and context of the tokens in the input sequence. As such, the (e.g., resulting) embeddings may be applied to one or more encoder(s) 610 of the generative LM 607.

In an example implementation, the encoder(s) 610 forms an encoder stack, where each encoder includes a self-attention layer and a feedforward network. In an example transformer architecture, each token (e.g., word) flows through a separate path. As such, each encoder may accept a sequence of vectors, passing each vector through the self-attention layer, then the feedforward network, and then upwards to the next encoder in the stack. Any known self-attention technique may be used. For example, to calculate a self-attention score for each token (word), a query vector, a key vector, and a value vector may be created for each token, and a self-attention score may be calculated for pairs of tokens by taking the dot product of the query vector with the corresponding key vectors, normalizing the resulting scores, multiplying by corresponding value vectors, and summing weighted value vectors. The encoder(s) 610 may apply multi-headed attention in which the attention mechanism is applied multiple times in parallel with different learned weight matrices. Any number of encoders may be cascaded to generate a context vector encoding the input. An attention projection layer 612 may convert the context vector into attention vectors (keys and values) for the decoder(s) 611.

In an example implementation, the decoder(s) 611 form a decoder stack, where each decoder includes a self-attention layer, an encoder-decoder self-attention layer that uses the attention vectors (keys and values) from the encoder(s) 610 to focus on relevant parts of the input sequence, and a feedforward network. As with the encoder(s) 610, in an example transformer architecture, each token (e.g., word) flows through a separate path in the decoder(s) 611. During a first pass, the decoder(s) 611, a classifier 613, and a generation mechanism 620 may generate a first token, and the generation mechanism 620 may apply the generated token as an input during a second pass. The process may repeat in a loop, successively generating and adding tokens (e.g., words) to the output from the preceding pass and applying the token embeddings of the composite sequence with positional encodings as an input to the decoder(s) 611 during a subsequent pass, sequentially generating one token at a time (known as auto-regression) until predicting a symbol or token that represents the end of the response. Within each decoder, the self-attention layer is typically constrained to attend only to preceding positions in the output sequence by applying a masking technique (e.g., setting future positions to negative infinity) before the softmax operation. In an example implementation, the encoder-decoder attention layer operates similarly to the (e.g., multi-headed) self-attention in the encoder(s) 610, except that it creates its queries from the layer below it and takes the keys and values (e.g., matrix) from the output of the encoder(s) 610.

As such, the decoder(s) 611 may output some decoded (e.g., vector) representation of the input being applied during a particular pass. The classifier 613 may include a multi-class classifier comprising one or more neural network layers that project the decoded (e.g., vector) representation into a corresponding dimensionality (e.g., one dimension for each supported word or token in the output vocabulary) and a softmax operation that converts logits to probabilities. As such, the generation mechanism 620 may select or sample a word or token based on a corresponding predicted probability (e.g., select the word with the highest predicted probability) and append it to the output from a previous pass, generating each word or token sequentially. The generation mechanism 620 may repeat the process, triggering successive decoder inputs and corresponding predictions until selecting or sampling a symbol or token that represents the end of the response, at which point the generation mechanism 620 may output the generated response.

FIG. 6C is a block diagram of an example implementation in which the generative LM 607 includes a decoder-only transformer architecture. For example, the decoder(s) 623 of FIG. 6C may operate similarly as the decoder(s) 611 of FIG. 6B except each of the decoder(s) 623 of FIG. 6C omits the encoder-decoder self-attention layer (since there is no encoder in this implementation). As such, the decoder(s) 623 may form a decoder stack, where each decoder includes a self-attention layer and a feedforward network. Furthermore, instead of encoding the input sequence, a symbol or token representing the end of the input sequence (or the beginning of the output sequence) may be appended to the input sequence, and the resulting sequence (e.g., corresponding embeddings with positional encodings) may be applied to the decoder(s) 623. As with the decoder(s) 611 of FIG. 6B, each token (e.g., word) may flow through a separate path in the decoder(s) 623, and the decoder(s) 623, a classifier 622, and a generation mechanism 621 may use auto-regression to sequentially generate one token at a time until predicting a symbol or token that represents the end of the response.

The classifier 622 and the generation mechanism 621 may operate similarly to the classifier 613 and the generation mechanism 620 of FIG. 6B, with the generation mechanism 621 selecting or sampling each successive output token based on a corresponding predicted probability and appending it to the output from a previous pass, generating each token sequentially until selecting or sampling a symbol or token that represents the end of the response. These and other architectures described herein are meant simply as examples, and other suitable architectures may be implemented within the scope of the present disclosure.

### Example Computing Device

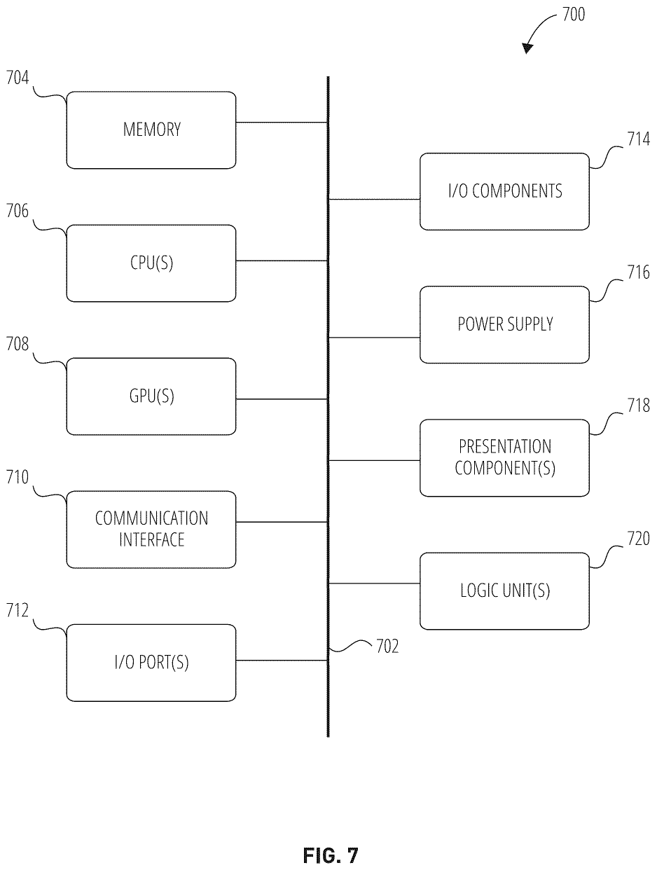

FIG. 7 is a block diagram of an example computing device 700 suitable for use in implementing some embodiments of the present disclosure. The computing device 700 may include an interconnect system 702 that directly or indirectly couples the following devices: memory 704, one or more central processing units (CPUs) 706, one or more graphics processing units (GPUs) 708, a communication interface 710, input/output (I/O) ports 712, input/output (I/O) components 714, a power supply 716, one or more presentation component(s) 718 (e.g., display [s]), and one or more logic unit(s) 720. In at least one embodiment, the computing device 700 may comprise one or more virtual machines (VMs), and/or any of the components thereof may comprise virtual components (e.g., virtual hardware components). For non-limiting examples, one or more of the GPU(s) 708 may comprise one or more vGPUs, one or more of the CPU(s) 706 may comprise one or more vCPUs, and/or one or more of the logic unit(s) 720 may comprise one or more virtual logic units. As such, a computing device 700 may include discrete components (e.g., a full GPU dedicated to the computing device 700), virtual components (e.g., a portion of a GPU dedicated to the computing device 700), or a combination thereof.

Although the various blocks of FIG. 7 are shown as connected via the interconnect system 702 with lines, this is not intended to be limiting and is for clarity only. For example, in some embodiments, a presentation component(s) 718, such as a display device, may be considered an I/O component 714 (e.g., if the display is a touch screen). As another example, the CPU(s) 706 and/or GPU(s) 708 may include memory (e.g., the memory 704 may be representative of a storage device in addition to the memory of the GPU(s) 708, the CPU(s) 706, and/or other components). As such, the computing device of FIG. 7 is merely illustrative. Distinction is not made between such categories as “workstation,” “server,” “laptop,′ “desktop,” “tablet,” “client device,” “mobile device,” “hand-held device,” “game console,” “electronic control unit (ECU),” “virtual reality system,” and/or other device or system types, as all are contemplated within the scope of the computing device of FIG. 7.

The interconnect system 702 may represent one or more links or busses, such as an address bus, a data bus, a control bus, or a combination thereof. The interconnect system 702 may include one or more bus or link types, such as an industry standard architecture (ISA) bus, an extended industry standard architecture (EISA) bus, a video electronics standards association (VESA) bus, a peripheral component interconnect (PCI) bus, a peripheral component interconnect express (PCIe) bus, and/or another type of bus or link. In some embodiments, there are direct connections between components. As an example, the CPU(s) 706 may be directly connected to the memory 704. Further, the CPU(s) 706 may be directly connected to the GPU(s) 708. Where there is direct, or point-to-point connection between components, the interconnect system 702 may include a PCIe link to carry out the connection. In these examples, a PCI bus need not be included in the computing device 700. The memory 704 may include any of a variety of computer-readable media. The computer-readable media may be any available media that may be accessed by the computing device 700. The computer-readable media may include both volatile and nonvolatile media, and removable and non-removable media. By way of example, and not limitation, the computer-readable media may comprise computer-storage media and communication media.

In some embodiments specifically related to implementing the AI agent system 104 described in FIG. 1, the computing device 700 may be configured to provide framework-agnostic performance analysis of AI agent workflows 116 through automated instrumentation and standardized profiling capabilities. The memory 704 may store custom callback handlers, intermediate step stream data, and standardized metadata extracted from different agent frameworks, while maintaining execution traces and performance metrics collected during multi-concurrency workflow analysis. The CPU(s) 706, GPU(s) 708, and/or logic unit(s) 720 may work cooperatively to perform the distinct functions of the AI agent system 104, including automatic framework discovery, callback handler registration for intercepting framework invocations across LangChain, LlamaIndex, CrewAI, and Semantic Kernel implementations, metadata normalization into unified data models, and execution of specialized profiling algorithms that generate latency analysis, bottleneck identification, concurrency analysis, and token efficiency measurements that provide granular insights into workflow performance characteristics previously impossible to obtain across heterogeneous agent implementations.

The computer-storage media may include both volatile and nonvolatile media and/or removable and non-removable media implemented in any method or technology for storage of information such as computer-readable instructions, data structures, program modules, and/or other data types. For example, the memory 704 may store computer-readable instructions (e.g., that represent a program(s) and/or a program element(s), such as an operating system. Computer-storage media may include, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which may be used to store the desired information and which may be accessed by computing device 700. As used herein, computer storage media does not comprise signals per se.

The computer storage media may embody computer-readable instructions, data structures, program modules, and/or other data types in a modulated data signal such as a carrier wave or other transport mechanism and includes any information delivery media. The term “modulated data signal” may refer to a signal that has one or more of its characteristics set or changed in such a manner as to encode information in the signal. By way of example, and not limitation, the computer storage media may include wired media such as a wired network or direct-wired connection, and wireless media such as acoustic, RF, infrared and other wireless media. Combinations of any of the above should also be included within the scope of computer-readable media.

The CPU(s) 706 may be configured to execute at least some of the computer-readable instructions to control one or more components of the computing device 700 to perform one or more of the methods and/or processes described herein. The CPU(s) 706 may each include one or more cores (e.g., one, two, four, eight, twenty-eight, seventy-two, etc.) that are capable of handling a multitude of software threads simultaneously. The CPU(s) 706 may include any type of processor, and may include different types of processors depending on the type of computing device 700 implemented (e.g., processors with fewer cores for mobile devices and processors with more cores for servers). For example, depending on the type of computing device 700, the processor may be an Advanced RISC Machines (ARM) processor implemented using Reduced Instruction Set Computing (RISC) or an x86 processor implemented using Complex Instruction Set Computing (CISC). The computing device 700 may include one or more CPU(s) 706 in addition to one or more microprocessors or supplementary co-processors, such as math co-processors.

In addition to or alternatively from the CPU(s) 706, the GPU(s) 708 may be configured to execute at least some of the computer-readable instructions to control one or more components of the computing device 700 to perform one or more of the methods and/or processes described herein. One or more of the GPU(s) 708 may be an integrated GPU (e.g., with one or more of the CPU(s) 706 and/or one or more of the GPU(s) 708 may be a discrete GPU. In embodiments, one or more of the GPU(s) 708 may be a coprocessor of one or more of the CPU(s) 706. The GPU(s) 708 may be used by the computing device 700 to render graphics (e.g., 3D graphics) or perform general purpose computations. For example, the GPU(s) 708 may be used for General-Purpose computing on GPUs (GPGPU). The GPU(s) 708 may include hundreds or thousands of cores that are capable of handling hundreds or thousands of software threads simultaneously. The GPU(s) 708 may generate pixel data for output images in response to rendering commands (e.g., rendering commands from the CPU(s) 706 received via a host interface). The GPU(s) 708 may include graphics memory, such as display memory, for storing pixel data or any other suitable data, such as GPGPU data. The display memory may be included as part of the memory 704. The GPU(s) 708 may include two or more GPUs operating in parallel (e.g., via a link). The link may directly connect the GPUs (e.g., using NVLINK) or may connect the GPUs through a switch (e.g., using NVSwitch). When combined together, each GPU(s) 708 may generate pixel data or GPGPU data for different portions of an output or for different outputs (e.g., a first GPU for a first image and a second GPU for a second image). Each GPU may include its own memory, or may share memory with other GPUs.

In addition to or alternatively from the CPU(s) 706 and/or the GPU(s) 708, the logic unit(s) 720 may be configured to execute at least some of the computer-readable instructions to control one or more components of the computing device 700 to perform one or more of the methods and/or processes described herein. In embodiments, the CPU(s) 706, the GPU(s) 708, and/or the logic unit(s) 720 may discretely or jointly perform any combination of the methods, processes and/or portions thereof. One or more of the logic unit(s) 720 may be part of and/or integrated in one or more of the CPU(s) 706 and/or the GPU(s) 708 and/or one or more of the logic unit(s) 720 may be discrete components or otherwise external to the CPU(s) 706 and/or the GPU(s) 708. In embodiments, one or more of the logic unit(s) 720 may be a coprocessor of one or more of the CPU(s) 706 and/or one or more of the GPU(s) 708.

Examples of the logic unit(s) 720 include one or more processing cores and/or components thereof, such as Data Processing Units (DPUs), Tensor Cores (TCs), Tensor Processing Units (TPUs), Pixel Visual Cores (PVCs), Vision Processing Units (VPUs), Graphics Processing Clusters (GPCs), Texture Processing Clusters (TPCs), Streaming Multiprocessors (SMs), Tree Traversal Units (TTUs), Artificial Intelligence Accelerators (AIAs), Deep Learning Accelerators (DLAs), Programmable Vision Accelerator (PVAs, which may include one or more direct memory access (DMA) systems, one or more vision or vector processing units (VPUs), one or more pixel processing engines (PPEs), e.g., including a 2D array of processing elements that each communicate north, south, east, and west with one or more other processing elements in the array, one or more decoupled accelerators or units, e.g., decoupled lookup table (DLUT) accelerators or units, etc.,), Vision Processing Units (VPUs), Optical Flow Accelerators (OFAs), Field Programmable Gate Arrays (FPGAs), Neuromorphic Chips, Quantum Processing Units (QPUs), Associative Process Units (APUs), Arithmetic-Logic Units (ALUs), Application-Specific Integrated Circuits (ASICs), Floating Point Units (FPUs), input/output (I/O) elements, peripheral component interconnect (PCI) or peripheral component interconnect express (PCIe) elements, and/or the like.

The communication interface 710 may include one or more receivers, transmitters, and/or transceivers that allow the computing device 700 to communicate with other computing devices via an electronic communication network, including wired and/or wireless communications. The communication interface 710 may include components and functionality to allow communication over any of a number of different networks, such as wireless networks (e.g., Wi-Fi, Z-Wave, Bluetooth, Bluetooth LE, ZigBee, etc.), wired networks (e.g., communicating over Ethernet or InfiniBand), low-power wide-area networks (e.g., LoRaWAN, SigFox, etc.), and/or the Internet. In one or more embodiments, logic unit(s) 720 and/or communication interface 710 may include one or more data processing units (DPUs) to transmit data received over a network and/or through interconnect system 702 directly to (e.g., a memory of) one or more GPU(s) 708.

The I/O port(s) 712 may allow the computing device 700 to be logically coupled to other devices including the I/O components 714, the presentation component(s) 718, and/or other components, some of which may be built in to (e.g., integrated in) the computing device 700. Illustrative I/O components 714 include a microphone, mouse, keyboard, joystick, game pad, game controller, satellite dish, scanner, printer, wireless device, etc. The I/O components 714 may provide a natural user interface (NUI) that processes air gestures, voice, or other physiological inputs generated by a user. In some instances, inputs may be transmitted to an appropriate network element for further processing. An NUI may implement any combination of speech recognition, stylus recognition, facial recognition, biometric recognition, gesture recognition both on screen and adjacent to the screen, air gestures, head and eye tracking, and touch recognition (as described in more detail below) associated with a display of the computing device 700. The computing device 700 may include one or more depth cameras, such as stereoscopic camera systems, infrared camera systems, RGB camera systems, touchscreen technology, and combinations of these, for gesture detection and recognition. Additionally, the computing device 700 may include accelerometers or gyroscopes (e.g., as part of an inertial measurement unit [IMU]) that allow detection of motion. In some examples, the output of the accelerometers or gyroscopes may be used by the computing device 700 to render immersive augmented reality or virtual reality.

The power supply 716 may include a hard-wired power supply, a battery power supply, or a combination thereof. The power supply 716 may provide power to the computing device 700 to allow the components of the computing device 700 to operate.

The presentation component(s) 718 may include a display (e.g., a monitor, a touch screen, a television screen, a heads-up-display (HUD), other display types, or a combination thereof), speakers, and/or other presentation components. The presentation component(s) 718 may receive data from other components (e.g., the GPU(s) 708, the CPU(s) 706, DPUs, etc.), and output the data (e.g., as an image, video, sound, etc.).

### Example Data Center

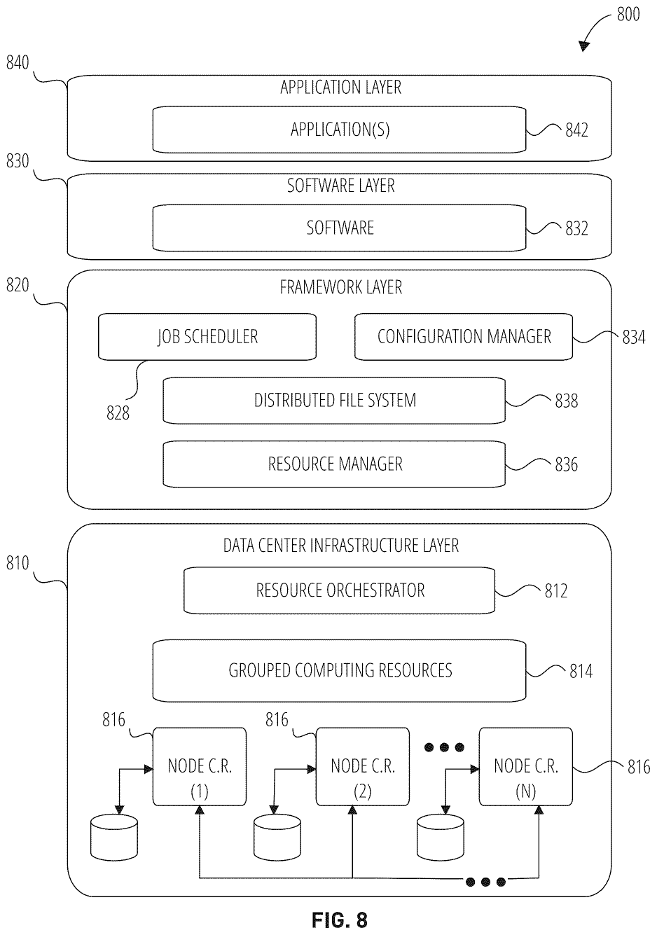

FIG. 8 illustrates an example data center 800 that may be used in at least one embodiment of the present disclosure. The data center 800 may include a data center infrastructure layer 810, a framework layer 820, a software layer 830, and/or an application layer 840.

As shown in FIG. 8, the data center infrastructure layer 810 may include a resource orchestrator 812, grouped computing resources 814, and node computing resources 816 (“node C.R.s”), shown as (1)-(N), where “N” represents any whole, positive integer. In at least one embodiment, node computing resources 816 may include, but are not limited to, any number of central processing units (CPUs) or other processors (including DPUs, accelerators, field programmable gate arrays (FPGAs), graphics processors or graphics processing units (GPUs), etc.), memory devices (e.g., dynamic read-only memory), storage devices (e.g., solid state or disk drives), network input/output (NW I/O) devices, network switches, virtual machines (VMs), power modules, and/or cooling modules, etc. In some embodiments, one or more nodes from among the node computing resources 816 may correspond to a server having one or more of the above-mentioned computing resources. In addition, in some embodiments, the node computing resources 816 may include one or more virtual components, such as vGPUs, vCPUs, and/or the like, and/or one or more of the node computing resources 816 may correspond to a virtual machine (VM).

In at least one embodiment, the grouped computing resources 814 may include separate groupings of the node computing resources 816 housed within one or more racks (not shown), or many racks housed in data centers at various geographical locations (also not shown). Separate groupings of node computing resources 816 within the grouped computing resources 814 may include grouped compute, network, memory or storage resources that may be configured or allocated to support one or more workloads. In at least one embodiment, several node computing resources 816 including CPUs, GPUs, DPUs, and/or other processors may be grouped within one or more racks to provide compute resources to support one or more workloads. The one or more racks may also include any number of power modules, cooling modules, and/or network switches, in any combination.

The resource orchestrator 812 may configure or otherwise control one or more node computing resources 816 and/or grouped computing resources 814. In at least one embodiment, the resource orchestrator 812 may include a software design infrastructure (SDI) management entity for the data center 800. The resource orchestrator 812 may include hardware, software, or some combination thereof.

In at least one embodiment, as shown in FIG. 8, the framework layer 820 may include a job scheduler 828, a configuration manager 834, a resource manager 836, and/or a distributed file system 838. The framework layer 820 may include a framework to support the software 832 of the software layer 830 and/or one or more application(s) 842 of the application layer 840. The software 832 or application(s) 842 may respectively include web-based service software or applications, such as those provided by Amazon Web Services, Google Cloud and Microsoft Azure. The framework layer 820 may be, but is not limited to, a type of free and open-source software web application framework such as Apache Spark™ (hereinafter “Spark”) that may use the distributed file system 838 for large-scale data processing (e.g., “big data”). In at least one embodiment, the job scheduler 828 may include a Spark driver to facilitate scheduling of workloads supported by various layers of the data center 800. The configuration manager 834 may be capable of configuring different layers such as the software layer 830 and the framework layer 820 including Spark and the distributed file system 838 for supporting large-scale data processing. The resource manager 836 may be capable of managing clustered or grouped computing resources mapped to or allocated for support of the distributed file system 838 and the job scheduler 828. In at least one embodiment, clustered or grouped computing resources may include the grouped computing resources 814 at the data center infrastructure layer 810. The resource manager 836 may coordinate with the resource orchestrator 812 to manage these mapped or allocated computing resources.

In at least one embodiment, the software 832 included in the software layer 830 may include software used by at least portions of the node computing resources 816, grouped computing resources 814, and/or the distributed file system 838 of the framework layer 820. One or more types of software may include, but are not limited to, Internet web page search software, e-mail virus scan software, database software, and streaming video content software.

In at least one embodiment, the application(s) 842 included in the application layer 840 may include one or more types of applications used by at least portions of the node computing resources 816, grouped computing resources 814, and/or distributed file system 838 of the framework layer 820. One or more types of applications may include, but are not limited to, any number of a genomics application, a cognitive compute, and a machine learning application, including training or inferencing software, machine learning framework software (e.g., PyTorch, TensorFlow, Caffe, etc.), and/or other machine learning applications used in conjunction with one or more embodiments.

In at least one embodiment, any of the configuration manager 834, resource manager 836, and resource orchestrator 812 may implement any number and type of self-modifying actions based on any amount and type of data acquired in any technically feasible fashion. Self-modifying actions may relieve a data center operator of the data center 800 from making possibly bad configuration decisions and possibly avoiding underutilized and/or poor performing portions of a data center. Each layer of the data center 800 contributes functionality to the AI agent system 104.

The data center 800 may include tools, services, software or other resources to train one or more machine learning models or predict or infer information using one or more machine learning models according to one or more embodiments described herein. For example, a machine learning model(s) may be trained by calculating weight parameters according to a neural network architecture using software and/or computing resources described above with respect to the data center 800. In at least one embodiment, trained or deployed machine learning models corresponding to one or more neural networks may be used to infer or predict information using resources described above with respect to the data center 800 by using weight parameters calculated through one or more training techniques, such as but not limited to those described herein.

In at least one embodiment, the data center 800 may use CPUs, application-specific integrated circuits (ASICs), GPUs, FPGAs, and/or other hardware (or virtual compute resources corresponding thereto) to perform training and/or inferencing using above-described resources. Moreover, one or more software and/or hardware resources described above may be configured as a service to allow users to train or perform inferencing of information, such as image recognition, speech recognition, or other artificial intelligence services.

The example data system 800 of FIG. 8 is designed to perform comprehensive context-agnostic human feedback collection for AI agent workflows 116 across multiple deployment layers of the data center 800 without requiring modifications to existing agent implementations. The AI agent system 104 can automatically discover and enhance agent workflows built using different frameworks such as LangChain, LlamaIndex, CrewAI, and Semantic Kernel while maintaining complete workflow transparency through dynamic callback handler registration and user input management across all layers of the data center 800 infrastructure.

At the application layer 840, the AI agent system 104 can enhance application(s) 842 that implement AI agent workflows 116 by deploying user input management capabilities through configuration-driven callback handler registration that enables context-agnostic human feedback collection. The API server 114 coordinates with application(s) 842 running at the application layer 840 to enable FE interface registration during workflow execution, enabling the user input manager 106 to coordinate human input requests including dynamic interface selection, automatic modality adaptation capabilities, and standardized request formatting that help developers enhance their agent implementations with human-in-the-loop capabilities across different deployment scenarios.

Within the software layer 830, the AI agent system 104 interfaces with software 832 components to perform dynamic front-end interface discovery including interface types, supported input modalities, timeout parameters, and callback function identifiers from registered user interface components. The user input manager 106 works with the software layer 830 to coordinate human input requests that route user feedback within context of agent workflow requirements and available interface capabilities, enabling the callback handler system to generate appropriate request formatting that captures workflow understanding including interface compatibility validation and hierarchical relationships between workflow components and front-end interfaces.

At the framework layer 820, the AI agent system 104 coordinates with the job scheduler 828, configuration manager 834, and resource manager 836 to enable framework-agnostic user input management deployment across heterogeneous agent implementations. The configuration component 110 works with the configuration manager 834 to define callback handler registration parameters, front-end interface compatibility criteria, and request routing specifications that guide the human feedback collection process. The user input manager 106 leverages the distributed file system 838 to store user interaction patterns and interface configuration data that enable comprehensive human-in-the-loop capabilities across multiple framework boundaries.

At the data center infrastructure layer 810, the AI agent system 104 communicates with the resource orchestrator 812 to coordinate user input management deployment across grouped computing resources 814 and node computing resources 816 where agent workflows are deployed. The observability platform 126 exports human interaction data to workflow monitoring systems through the resource orchestrator 812, enabling cross-framework user input management where agent workflows built in one framework can request human feedback using interface registration systems associated with different front-end modalities. The comprehensive user input management capabilities enable the AI agent system 104 to provide granular human feedback collection through context-agnostic request routing previously impossible to obtain across multi-framework agent architectures deployed across the data center 800 infrastructure.

### Example Network Environments

Network environments suitable for use in implementing embodiments of the disclosure may include one or more client devices, servers, network attached storage (NAS), other backend devices, and/or other device types. The client devices, servers, and/or other device types (e.g., each device) may be implemented on one or more instances of the computing device 700 of FIG. 7, e.g., each device may include similar components, features, and/or functionality of the computing device 700. In addition, where backend devices (e.g., servers, NAS, etc.) are implemented, the backend devices may be included as part of the data center 800, an example of which is described in more detail herein with respect to FIG. 8.

Components of a network environment may communicate with each other via a network(s), which may be wired, wireless, or both. The network may include multiple networks, or a network of networks. By way of example, the network may include one or more Wide Area Networks (WANs), one or more Local Area Networks (LANs), one or more public networks such as the Internet and/or a public switched telephone network (PSTN), and/or one or more private networks. Where the network includes a wireless telecommunications network, components such as a base station, a communications tower, or even access points (as well as other components) may provide wireless connectivity.

Compatible network environments may include one or more peer-to-peer network environments—in which case a server may not be included in a network environment- and one or more client-server network environments—in which case one or more servers may be included in a network environment. In peer-to-peer network environments, functionality described herein with respect to a server(s) may be implemented on any number of client devices.

In at least one embodiment, a network environment may include one or more cloud-based network environments, a distributed computing environment, a combination thereof, etc. A cloud-based network environment may include a framework layer, a job scheduler, a resource manager, and a distributed file system implemented on one or more of servers, which may include one or more core network servers and/or edge servers. A framework layer may include a framework to support software of a software layer and/or one or more application(s) of an application layer. The software or application(s) may respectively include web-based service software or applications. In embodiments, one or more of the client devices may use the web-based service software or applications (e.g., by accessing the service software and/or applications via one or more application programming interfaces (APIs)). The framework layer may be, but is not limited to, a type of free and open-source software web application framework such as that may use a distributed file system for large-scale data processing (e.g., “big data”).

A cloud-based network environment may provide cloud computing and/or cloud storage that carries out any combination of computing and/or data storage functions described herein (or one or more portions thereof). Any of these various functions may be distributed over multiple locations from central or core servers (e.g., of one or more data centers that may be distributed across a state, a region, a country, the globe, etc.). If a connection to a user (e.g., a client device) is relatively close to an edge server(s), a core server(s) may designate at least a portion of the functionality to the edge server(s). A cloud-based network environment may be private (e.g., limited to a single organization), may be public (e.g., available to many organizations), and/or a combination thereof (e.g., a hybrid cloud environment).

The client device(s) may include at least some of the components, features, and functionality of the example computing device 700 described herein with respect to FIG. 7. By way of example and not limitation, a client device may be embodied as a Personal Computer (PC), a laptop computer, a mobile device, a smartphone, a tablet computer, a smart watch, a wearable computer, a Personal Digital Assistant (PDA), an MP3 player, a virtual reality headset, a Global Positioning System (GPS) or device, a video player, a video camera, a surveillance device or system, a vehicle, a boat, a flying vessel, a virtual machine, a drone, a robot, a handheld communications device, a hospital device, a gaming device or system, an entertainment system, a vehicle computer system, an embedded system controller, a remote control, an appliance, a consumer electronic device, a workstation, an edge device, any combination of these delineated devices, or any other suitable device.

The disclosure may be described in the general context of computer code or machine-useable instructions, including computer-executable instructions such as program modules, being executed by a computer or other machine, such as a personal data assistant or other handheld device. Generally, program modules including routines, programs, objects, components, data structures, etc., refer to code that perform particular tasks or implement particular abstract data types. The disclosure may be practiced in a variety of system configurations, including hand-held devices, consumer electronics, general-purpose computers, more specialty computing devices, etc. The disclosure may also be practiced in distributed computing environments where tasks are performed by remote-processing devices that are linked through a communications network.

As used herein, a recitation of “and/or” with respect to two or more elements should be interpreted to mean only one element, or a combination of elements. For example, “element A, element B, and/or element C” may include only element A, only element B, only element C, element A and element B, element A and element C, element B and element C, or elements A, B, and C. In addition, “at least one of element A or element B” may include at least one of element A, at least one of element B, or at least one of element A and at least one of element B. Further, “at least one of element A and element B” may include at least one of element A, at least one of element B, or at least one of element A and at least one of element B.

The subject matter of the present disclosure is described with specificity herein to meet statutory requirements. However, the description itself is not intended to limit the scope of this disclosure. Rather, the inventors have contemplated that the claimed subject matter might also be embodied in other ways, to include different steps or operations or combinations of steps or operations similar to the ones described in this document, in conjunction with other present or future technologies. Moreover, although the terms “step” and/or “block” and/or “operation” may be used herein to connote different elements of methods employed, the terms should not be interpreted as implying any particular order among or between various steps herein disclosed unless and except when the order of individual steps is explicitly described.

### Examples

Specific example embodiments are now described. In view of the above-described implementations of subject matter this application discloses the following list of examples, wherein one feature of an example in isolation or more than one feature of an example, taken in combination and, optionally, in combination with one or more features of one or more further examples are further examples also falling within the disclosure of this application.

Example 1: One or more processors comprising processing circuitry to perform operations comprising: receiving, by a user input manager of an artificial intelligence (AI) agent system, a request for user input from one or more AI agent workflows during execution of the one or more AI agent workflows; based on the request for the user input, identifying, by the user input manager, a registered callback handler associated with a user interface front-end from a plurality of available user interface front-ends, each of the available user interface front-ends to interact with a user through a different modality; transmitting the request for user input to the identified user interface front-end via the registered callback handler, the identified user interface front-end processes the request for user input according to a specific interaction modality of the identified user interface front-end and obtains the user input; and routing, by the user input manager, a response from the identified user interface front-end comprising the obtained user input to the one or more AI agent workflows.

Example 2: The system of Example 1, wherein the operations comprise: monitoring, by the user input manager, the plurality of available user interface front-ends during system initialization; executing a registration process where each of the plurality of available user interface front-ends provides a callback function identifier; and storing the callback function identifier for each of the plurality of available user interface front-ends in an association data structure mapping front-end types to callback function identifiers.

Example 3: The system of any one of Examples 1-2, wherein the operations comprise: analyzing the request for user input to determine a specific input type; generating a formatted request message containing the specific input type and one or more associated parameters; and transmitting the formatted request message to the identified user interface front-end.

Example 4: The system of Example 3, wherein the operations comprise: detecting when the identified user interface front-end fails to support the specific input type; generating an error notification message indicating that the specific input type is unsupported; transmitting the error notification back to the one or more AI agent workflows from which the request was received; and enabling the one or more AI agent workflows to continue execution with one or more alternative input request strategies.

Example 5: The system of any one of Examples 1-4, wherein the plurality of available user interface front-ends comprise at least one of a command line interface, web interface, or a voice input/output interface, and wherein the operations comprise: executing one or more modality-specific interaction protocols for each type of user interface front-end.

Example 6: The system of any one of Examples 1-5, wherein the operations comprise: determining one or more confidence scores for one or more decision-making processes of the one or more AI agent workflows; detecting when the one or more confidence scores fall below one or more predetermined threshold values; automatically triggering a user input request based on detecting that the one or more confidence scores fall below the one or more predetermined threshold values; and integrating user feedback into one or more subsequent agent workflow decision-making processes.

Example 7: The system of Example 6, wherein the operations comprise: analyzing one or more agent workflow execution patterns to identify one or more repetitive loop behaviors; detecting when the one or more AI agent workflows call identical functions with failing arguments in the one or more repetitive loop behaviors; interrupting execution of the one or more repetitive loop behaviors automatically; and causing the triggering of the user input request for clarification or alternative processing directions as a result of interrupting the execution.

Example 8: The system of any one of Examples 1-7, wherein the operations comprise: executing AI-mediated transformation of the request for user input received from the one or more AI agent workflows having a first complexity into a second complexity that is simpler than the first complexity; processing one or more user responses in the second complexity and converting the one or more user requests into one or more structured data formats; and transmitting the converted one or more user requests in the one or more structured data formats to the one or more AI agent workflows.

Example 9: The system of Example 8, wherein the first complexity comprises a technical specification requiring a structured data format and the second complexity comprises a natural language query.

Example 10: The system of any one of Examples 8-9, wherein the operations comprise: analyzing the request for user input to determine that a geographic location is required based on data schema specification; detecting that the identified user interface front-end comprises a web-based user interface capable of rendering one or more interactive graphical elements; generating an interactive map user interface component configured to receive one or more geographic coordinate selections from the user; and rendering the interactive map within the web-based user interface to enable point-and-click selection of a desired geographic location for obtaining the response comprising the user input.

Example 11: The system of any one of Examples 8-10, wherein the operations comprise: analyzing the request received from the one or more AI agent workflows to identify a data schema specification; dynamically generating a user interface component based on the identified data schema specification; and rendering an input widget comprising the user interface component to receive the response from the identified user interface front-end.

Example 12: The system of Example 11, wherein the data schema specification comprises at least one of a set of data types comprising at least one of a date selection, a choice list, or a numerical rating scale, wherein the user interface component comprises one or more input elements including at least one of a calendar widget for date input, a dropdown menu for choice selection, or a star rating system for numerical scale; the operations comprising: adapting the rendered input widget to match a specific interaction capability and display characteristic of the identified user interface front-end.

Example 13: The system of any one of Examples 11-12, wherein the operations comprise: monitoring user interaction history to identify one or more common input patterns or preferences; and pre-filling generated interface components with frequently used values or suggestions based on identifying the one or more common input patterns or preferences.

Example 14: The system of any one of Examples 1-13, wherein the operations comprise: detecting, by the user input manager, multiple concurrent requests for user input from different AI agent workflows executing simultaneously; generating a queue data structure to manage the multiple concurrent requests in temporal or priority order; and processing each request of the multiple concurrent requests sequentially through the registered callback handler.

Example 15: The system of any one of Examples 1-14, wherein the one or more processors are comprised in at least one of: a control system for an autonomous or semi-autonomous machine; a perception system for the autonomous or semi-autonomous machine; a system for performing simulation operations; a system for performing digital twin operations; a system for performing light transport simulation; a system for performing collaborative content creation for 3D assets; a system for performing deep learning operations; a system for performing remote operations; a system for performing real-time streaming; a system for generating or presenting one or more of augmented reality content, virtual reality content, or mixed reality content; a system implemented using an edge device; a system implemented using a robot; a system for performing conversational artificial intelligence (AI) operations; a system implementing one or more multi-modal language models; a system implementing one or more large language models (LLMs); a system implementing one or more small language models (SLMs); a system implementing one or more vision language models (VLMs); a system for generating synthetic data; a system for generating synthetic data using AI; a system incorporating one or more virtual machines (VMs); a system using or deploying one or more inference microservices; a system incorporating one or more machine learning models deployed in a service or microservice along with an OS-level virtualization package; a system implemented at least partially in a data center; or a system implemented at least partially using cloud computing resources.

Example 16: A system comprising one or more processors to perform operations comprising: receiving, by a user input manager of an artificial intelligence (AI) agent system, a request for user input from one or more AI agent workflows during execution of the one or more AI agent workflows; based on the request for the user input, identifying, by the user input manager, a registered callback handler associated with a user interface front-end from a plurality of available user interface front-ends, each of the available user interface front-ends to interact with a user through a different modality; transmitting the request for user input to the identified user interface front-end via the registered callback handler, the identified user interface front-end processes the request for user input according to a specific interaction modality of the identified user interface front-end and obtains the user input; and routing, by the user input manager, a response from the identified user interface front-end comprising the obtained user input to the one or more AI agent workflows.

Example 17: The system of Example 16, wherein the system is comprised in at least one of: a control system for an autonomous or semi-autonomous machine; a perception system for the autonomous or semi-autonomous machine; a system for performing simulation operations; a system for performing digital twin operations; a system for performing light transport simulation; a system for performing collaborative content creation for 3D assets; a system for performing deep learning operations; a system for performing remote operations; a system for performing real-time streaming; a system for generating or presenting one or more of augmented reality content, virtual reality content, or mixed reality content; a system implemented using an edge device; a system implemented using a robot; a system for performing conversational artificial intelligence (AI) operations; a system implementing one or more multi-modal language models; a system implementing one or more large language models (LLMs); a system implementing one or more small language models (SLMs); a system implementing one or more vision language models (VLMs); a system for generating synthetic data; a system for generating synthetic data using AI; a system incorporating one or more virtual machines (VMs); a system using or deploying one or more inference microservices; a system incorporating one or more machine learning models deployed in a service or microservice along with an OS-level virtualization package; a system implemented at least partially in a data center; or a system implemented at least partially using cloud computing resources.

Example 18: A method comprising: receiving, by a user input manager of an artificial intelligence (AI) agent system, a request for user input from one or more AI agent workflows during execution of the one or more AI agent workflows; based on the request for the user input, identifying, by the user input manager, a registered callback handler associated with a user interface front-end from a plurality of available user interface front-ends, each of the available user interface front-ends to interact with a user through a different modality; transmitting the request for user input to the identified user interface front-end via the registered callback handler, the identified user interface front-end processes the request for user input according to a specific interaction modality of the identified user interface front-end and obtains the user input; and routing, by the user input manager, a response from the identified user interface front-end comprising the obtained user input to the one or more AI agent workflows.

Example 19: The method of Example 18, comprising: monitoring, by the user input manager, the plurality of available user interface front-ends during system initialization; executing a registration process where each of the plurality of available user interface front-ends provides a callback function identifier; and storing the callback function identifier for each of the plurality of available user interface front-ends in an association data structure mapping front-end types to callback function identifiers.

Example 20: The method of any one of Examples 18-19, wherein the method is performed by at least one of: a control system for an autonomous or semi-autonomous machine; a perception system for the autonomous or semi-autonomous machine; a system for performing simulation operations; a system for performing digital twin operations; a system for performing light transport simulation; a system for performing collaborative content creation for 3D assets; a system for performing deep learning operations; a system for performing remote operations; a system for performing real-time streaming; a system for generating or presenting one or more of augmented reality content, virtual reality content, or mixed reality content; a system implemented using an edge device; a system implemented using a robot; a system for performing conversational artificial intelligence (AI) operations; a system implementing one or more multi-modal language models; a system implementing one or more large language models (LLMs); a system implementing one or more small language models (SLMs); a system implementing one or more vision language models (VLMs); a system for generating synthetic data; a system for generating synthetic data using AI; a system incorporating one or more virtual machines (VMs); a system using or deploying one or more inference microservices; a system incorporating one or more machine learning models deployed in a service or microservice along with an OS-level virtualization package; a system implemented at least partially in a data center; or a system implemented at least partially using cloud computing resources.

What is claimed is:

1. One or more processors comprising processing circuitry to perform operations comprising:
receiving, by a user input manager of an artificial intelligence (AI) agent system, a request for user input from one or more AI agent workflows during execution of the one or more AI agent workflows;
based on the request for the user input, identifying, by the user input manager, a registered callback handler associated with a user interface front-end from a plurality of available user interface front-ends, each of the available user interface front-ends to interact with a user through a different modality;
transmitting the request for user input to the identified user interface front-end via the registered callback handler, the identified user interface front-end processing the request for user input according to a specific interaction modality of the identified user interface front-end and obtaining the user input; and
routing, by the user input manager, a response from the identified user interface front-end comprising the obtained user input to the one or more AI agent workflows.

2. The one or more processors of claim 1, wherein the operations comprise:
monitoring, by the user input manager, the plurality of available user interface front-ends during system initialization;
executing a registration process where each of the plurality of available user interface front-ends provides a callback function identifier; and
storing the callback function identifier for each of the plurality of available user interface front-ends in an association data structure mapping front-end types to callback function identifiers.

3. The one or more processors of claim 1, wherein the operations comprise:
analyzing the request for user input to determine a specific input type;
generating a formatted request message containing the specific input type and one or more associated parameters; and
transmitting the formatted request message to the identified user interface front-end.

4. The one or more processors of claim 3, wherein the operations comprise:
detecting when the identified user interface front-end fails to support the specific input type;
generating an error notification message indicating that the specific input type is unsupported;
transmitting the error notification back to the one or more AI agent workflows from which the request was received; and
enabling the one or more AI agent workflows to continue execution with one or more alternative input request strategies.

5. The one or more processors of claim 1, wherein the plurality of available user interface front-ends comprises at least one of a command line interface, web interface, or a voice input/output interface, and wherein the operations comprise:
executing one or more modality-specific interaction protocols for each type of user interface front-end.

6. The one or more processors of claim 1, wherein the operations comprise:
determining one or more confidence scores for one or more decision-making processes of the one or more AI agent workflows;
detecting when the one or more confidence scores fall below one or more predetermined threshold values;
automatically triggering a user input request based on detecting that the one or more confidence scores fall below the one or more predetermined threshold values; and
integrating user feedback into one or more subsequent agent workflow decision-making processes.

7. The one or more processors of claim 6, wherein the operations comprise:
analyzing one or more agent workflow execution patterns to identify one or more repetitive loop behaviors;
detecting when the one or more AI agent workflows call identical functions with failing arguments in the one or more repetitive loop behaviors;
interrupting execution of the one or more repetitive loop behaviors automatically; and
causing the triggering of the user input request for clarification or alternative processing directions as a result of interrupting the execution.

8. The one or more processors of claim 1, wherein the operations comprise:
executing AI-mediated transformation of the request for user input received from the one or more AI agent workflows having a first complexity into a second complexity that is simpler than the first complexity;
processing one or more user responses in the second complexity and converting the one or more user requests into one or more structured data formats; and
transmitting the converted one or more user requests in the one or more structured data formats to the one or more AI agent workflows.

9. The one or more processors of claim 8, wherein the first complexity comprises a technical specification requiring a structured data format and the second complexity comprises a natural language query.

10. The one or more processors of claim 8, wherein the operations comprise:
analyzing the request for user input to determine that a geographic location is required based on data schema specification;
detecting that the identified user interface front-end comprises a web-based user interface capable of rendering one or more interactive graphical elements;
generating an interactive map user interface component configured to receive one or more geographic coordinate selections from the user; and
rendering the interactive map within the web-based user interface to enable point-and-click selection of a desired geographic location for obtaining the response comprising the user input.

11. The one or more processors of claim 8, wherein the operations comprise:
analyzing the request received from the one or more AI agent workflows to identify a data schema specification;
dynamically generating a user interface component based on the identified data schema specification; and
rendering an input widget comprising the user interface component to receive the response from the identified user interface front-end.

12. The one or more processors of claim 11, wherein the data schema specification comprises at least one of a set of data types comprising at least one of a date selection, a choice list, or a numerical rating scale, wherein the user interface component comprises one or more input elements including at least one of a calendar widget for date input, a dropdown menu for choice selection, or a star rating system for numerical scale; the operations comprising:
adapting the rendered input widget to match a specific interaction capability and display characteristic of the identified user interface front-end.

13. The one or more processors of claim 11, wherein the operations comprise:
monitoring user interaction history to identify one or more common input patterns or preferences; and
pre-filling generated interface components with frequently used values or suggestions based on identifying the one or more common input patterns or preferences.

14. The one or more processors of claim 1, wherein the operations comprise:
detecting, by the user input manager, multiple concurrent requests for user input from different AI agent workflows executing simultaneously;
generating a queue data structure to manage the multiple concurrent requests in temporal or priority order; and
processing each request of the multiple concurrent requests sequentially through the registered callback handler.

15. The one or more processors of claim 1, wherein the one or more processors are comprised in at least one of:
a control system for an autonomous or semi-autonomous machine;
a perception system for the autonomous or semi-autonomous machine;
a system for performing simulation operations;
a system for performing digital twin operations;
a system for performing light transport simulation;
a system for performing collaborative content creation for 3D assets;
a system for performing deep learning operations;
a system for performing remote operations;
a system for performing real-time streaming;
a system for generating or presenting one or more of augmented reality content, virtual reality content, or mixed reality content;
a system implemented using an edge device;
a system implemented using a robot;
a system for performing conversational artificial intelligence (AI) operations;
a system implementing one or more multi-modal language models;
a system implementing one or more large language models (LLMs);
a system implementing one or more small language models (SLMs);
a system implementing one or more vision language models (VLMs);
a system for generating synthetic data;
a system for generating synthetic data using AI;
a system incorporating one or more virtual machines (VMs);
a system using or deploying one or more inference microservices;
a system incorporating one or more machine learning models deployed in a service or microservice along with an OS-level virtualization package;
a system implemented at least partially in a data center; or
a system implemented at least partially using cloud computing resources.

16. A system comprising one or more processors to perform operations comprising:
receiving, by a user input manager of an artificial intelligence (AI) agent system, a request for user input from one or more AI agent workflows during execution of the one or more AI agent workflows;
based on the request for the user input, identifying, by the user input manager, a registered callback handler associated with a user interface front-end from a plurality of available user interface front-ends, each of the available user interface front-ends to interact with a user through a different modality;
transmitting the request for user input to the identified user interface front-end via the registered callback handler, the identified user interface front-end processing the request for user input according to a specific interaction modality of the identified user interface front-end and obtaining the user input; and
routing, by the user input manager, a response from the identified user interface front-end comprising the obtained user input to the one or more AI agent workflows.

17. The system of claim 16, wherein the system is comprised in at least one of:
a control system for an autonomous or semi-autonomous machine;
a perception system for the autonomous or semi-autonomous machine;
a system for performing simulation operations;
a system for performing digital twin operations;
a system for performing light transport simulation;
a system for performing collaborative content creation for 3D assets;
a system for performing deep learning operations;
a system for performing remote operations;
a system for performing real-time streaming;
a system for generating or presenting one or more of augmented reality content, virtual reality content, or mixed reality content;
a system implemented using an edge device;
a system implemented using a robot;
a system for performing conversational artificial intelligence (AI) operations;
a system implementing one or more multi-modal language models;
a system implementing one or more large language models (LLMs);
a system implementing one or more small language models (SLMs);
a system implementing one or more vision language models (VLMs);
a system for generating synthetic data;
a system for generating synthetic data using AI;
a system incorporating one or more virtual machines (VMs);
a system using or deploying one or more inference microservices;
a system incorporating one or more machine learning models deployed in a service or microservice along with an OS-level virtualization package;
a system implemented at least partially in a data center; or
a system implemented at least partially using cloud computing resources.

18. A method comprising:
receiving, by a user input manager of an artificial intelligence (AI) agent system, a request for user input from one or more AI agent workflows during execution of the one or more AI agent workflows;
based on the request for the user input, identifying, by the user input manager, a registered callback handler associated with a user interface front-end from a plurality of available user interface front-ends, each of the available user interface front-ends to interact with a user through a different modality;
transmitting the request for user input to the identified user interface front-end via the registered callback handler, the identified user interface front-end processes the request for user input according to a specific interaction modality of the identified user interface front-end and obtains the user input; and
routing, by the user input manager, a response from the identified user interface front-end comprising the obtained user input to the one or more AI agent workflows.

19. The method of claim 18, comprising:
monitoring, by the user input manager, the plurality of available user interface front-ends during system initialization;
executing a registration process where each of the plurality of available user interface front-ends provides a callback function identifier; and
storing the callback function identifier for each of the plurality of available user interface front-ends in an association data structure mapping front-end types to callback function identifiers.

20. The method of claim 18, wherein the method is performed by at least one of:
a control system for an autonomous or semi-autonomous machine;
a perception system for the autonomous or semi-autonomous machine;
a system for performing simulation operations;
a system for performing digital twin operations;
a system for performing light transport simulation;
a system for performing collaborative content creation for 3D assets;
a system for performing deep learning operations;
a system for performing remote operations;
a system for performing real-time streaming;
a system for generating or presenting one or more of augmented reality content, virtual reality content, or mixed reality content;
a system implemented using an edge device;
a system implemented using a robot;
a system for performing conversational artificial intelligence (AI) operations;
a system implementing one or more multi-modal language models;
a system implementing one or more large language models (LLMs);
a system implementing one or more small language models (SLMs);
a system implementing one or more vision language models (VLMs);
a system for generating synthetic data;
a system for generating synthetic data using AI;
a system incorporating one or more virtual machines (VMs);
a system using or deploying one or more inference microservices;
a system incorporating one or more machine learning models deployed in a service or microservice along with an OS-level virtualization package;
a system implemented at least partially in a data center; or
a system implemented at least partially using cloud computing resources.
